(19) United States
(12) Patent Application Publication
(10) Pub. No.: US 2023/0214951 A1
(43) Pub. Date: Jul. 6, 2023

(54) OPTIMIZING PLACEMENT OF AN ASSET ARRAY IN A LOADING AREA

(71) Applicant: United Parcel Service of America, Inc., Atlanta, GA (US)

(72) Inventors: Mark Grob, Atlanta, GA (US); George Offenhauser, Atlanta, GA (US)

(21) Appl. No.: 17/566,459

(22) Filed: Dec. 30, 2021

(51) Int. Cl. G06Q 50/28; G06Q 10/06

(52) U.S. Cl. CPC G06Q 50/28; G06Q 10/06393

(57) ABSTRACT

The present disclosure is directed, in part, to improving existing technologies by selecting a configuration for an asset array based on features of both the assets and a loading area. In order to select the configuration, a plurality of configurations may be generated and scored. The scores may be based on any number of factors, such as the number of return trips required, the time required to deliver all packages, or another aspect of asset loading and/or delivery. Based on the scores, a particular configuration is selected for the asset array. Instructions are provided for loading the vehicle in accordance with the set of loading area arrangements associated with the selected configuration, such as step-by-step instructions for loading each asset in a particular position and orientation may be provided to a computing device.

### BACKGROUND

Vehicles or facilities have one or more loading areas for which assets (e.g., packages, equipment, or tools) can be placed. For example, delivery vehicles have a loading area (e.g., a trunk or cargo compartment) in which packages are loaded for delivery to final destinations. The assets can be loaded into the loading area in many different configurations, with certain configurations being more efficient than others. For example, one configuration may allow all of the relevant packages to fit into the loading area, thus facilitating delivery in a single trip. Meanwhile, a different configuration may accommodate only a portion of the relevant packages in the loading area and may thus require a return trip to a central loading location (e.g., a sorting facility) in order to retrieve and then deliver the remaining packages.

Existing technologies have various shortcomings in terms of providing intelligent functionality for identifying efficient or optimal configurations to load assets into loading areas. For example, existing immersive technologies (e.g., Augmented Reality and Mixed Reality) and mobile devices lack the functionality to predict or indicate (e.g., via a visualization indicator or on-chip camera) areas within a vehicle that assets should be placed. These technologies also fail to predict or indicate the order the assets should be placed in the vehicle, among other things.

### SUMMARY

The present disclosure is directed, in part, to improving existing technologies by determining an optimized configuration for an asset array (e.g., multiple packages for multiple deliveries) based on features of both the assets and a loading area. For example, various embodiments determine a loading configuration by determining where, inside a delivery vehicle, packages should be placed and in what order. Another example delivery configuration includes a set of loading area arrangements, with each loading area arrangement corresponding to an arrangement of packages in the loading area of the delivery vehicle during a trip from a package loading location to a shipping destination for the relevant packages. For example, if not all of the packages fit into the loading area of the delivery vehicle and a return trip to the package loading location is needed in order to retrieve additional packages for delivery, then the delivery configuration may include two loading area arrangements—one arrangement for the packages included in the first delivery trip and one arrangement for the packages included in the second delivery trip. Each loading area arrangement may specify a position and orientation of each package in the loading area of the vehicle.

In order to determine the optimized configuration, a plurality of configurations may be generated and scored. The scores may be based on any number of factors relevant to optimization, such as the number of return trips required, the time required to deliver all of the packages, or another aspect of package loading and/or delivery. Based on the scores, a particular configuration is determined to be the optimal configuration for the asset array. Instructions are provided for loading the vehicle in accordance with the set of loading area arrangements associated with the optimized configuration. For example, step-by-step instructions for loading each asset in a particular position and orientation may be provided to a computing device.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached figures, which are intended to be exemplary and non-limiting, wherein:

FIG. 1 is a schematic diagram of augmented reality functionality to assist a user in loading a set of packages into a personal vehicle based on identifying an optimal loading configuration for the set of packages, according to some embodiments.

FIG. 2 is block diagram of an example computing system architecture suitable for implementing some embodiments.

FIG. 3 is a schematic diagram illustrating different personal vehicles and package arrays that must be loaded into one or more respective loading areas, according to some embodiments.

FIG. 4 is a schematic diagram illustrating the potential inputs fed to a neural network (or other machine learning models) to generate predicted inferences, in accordance with embodiments of the present disclosure.

FIG. 5A is a schematic diagram of a virtual simulation illustrating a single load area and assets for learning one or more optimal configurations, according to some embodiments.

FIG. 5B is a schematic diagram of a virtual simulation illustrating multiple load areas for learning one or more optimal configurations, according to some embodiments.

FIG. 6 is a screenshot of an immersive technology interface, according to some embodiments.

FIG. 7 is a screenshot of an example user interface for identifying an optimal delivery configuration, according to some embodiments.

FIG. 8 is a flow diagram of an example process for training a machine learning model, according to some embodiments.

FIG. 9 is a flow diagram of an example process for providing loading instructions to users for loading a plurality of assets into a loading area in accordance with a selected configuration, according to some embodiments.

FIG. 10 is a schematic diagram of an example computing environment in which aspects of the present disclosure are employed in, according to some embodiments.

FIG. 11 is a block diagram of an analysis computing entity of FIG. 10, according to some embodiments.

FIG. 12 is a block diagram of a computing entity of FIG. 10, according to some embodiments.

### DETAILED DESCRIPTION

The technology of the present disclosure is described with specificity herein to meet statutory requirements. However, the description itself is not intended to limit the scope of this patent. Rather, it is contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various embodiments of the technology described herein provides an optimized configuration for placement of an asset array based on features of both the assets and the loading area of the vehicle, among other things. An example delivery configuration includes a set of loading area arrangements, with each loading area arrangement corresponding to an arrangement of packages in the loading area of the delivery vehicle during a trip from a package loading location (e.g., a sorting center) to a shipping destination for the relevant packages. Optimization may be based on the number of return trips required, the time required to deliver all of the packages, or another aspect of package loading and/or delivery, among other things. Step-by-step instructions for loading each asset in a particular position and orientation may be provided to a computing device in order to facilitate loading the vehicle in accordance with the optimized configuration.

Existing immersive technologies fail to employ intelligent functionality for determining an optimal configuration to load assets into vehicles. Immersive technologies merge the physical world with a digital or simulated reality. Examples of immersive technologies included Augmented Reality (AR), Virtual Reality (VR), and Mixed Reality (MR). Currently these technologies provide a rich gaming experience for users, provide training or education to users, and immersive E-Commerce and shopping tools, among other things. However, these technologies currently lack the functionality to predict or indicate (e.g., via an indicator over a real-world picture of a trunk) areas within a vehicle that assets should be placed. These technologies also fail to predict or indicate the order the assets should be placed in the vehicle. In other words, these technologies fail to identify a configuration (e.g., among a plurality of configurations) as the optimized configuration for an asset array. Moreover, these immersive technologies are typically heavy and bulky, thereby negatively affecting the user experience (e.g., via obtrusive headsets) because the user is not able to seamlessly navigate and perform tasks.

Existing user devices (e.g., mobile phones) also fail to employ intelligent functionality for identifying an optimal configuration for assisting in the loading of assets into vehicles. The capabilities of mobile phones have drastically improved over recent years. For example, from the incorporation of high resolution cameras to produce high quality videos and pictures, to automated screen orientation (e.g., via accelerometers), and Quick Response (QR) code capabilities, mobile phones can perform a variety of different tasks. However, mobile phones currently lack the functionality to predict or employ the sensors to map an interior of a vehicle and indicate areas within a vehicle that assets should be placed. These user devices also fail to predict or indicate the order the assets should be placed in the vehicle. In other words, these technologies fail to identify a configuration as the optimized configuration for an asset array.

Existing logistics-based technologies are inaccurate and static in calculating where packages should be placed in delivery vehicles. For example, existing logistics web applications for optimizing the loading of a dedicated asset assume that cargo areas have regular shapes and sizes (e.g., a rectangular prism), such as those found in typical logistics-based tractor trailers or delivery trucks. Because of this, they fail to map out or even consider varied parameters among personal vehicles, such as number of seating rows, the volume interior space associated with a floorboard, the surface area of a seat, and the like.

By way of background, “private vehicle drivers” or “personal vehicle drivers” (“PVDs”) utilize a personal vehicle to make deliveries. In contrast to a fleet of dedicated delivery trucks or vans, which often have consistent shapes and sizes, personal vehicles take a wide variety of shapes and sizes. Accordingly, PVDs benefit from customized delivery configurations in real-time, based on the particular vehicle and the particular packages to be loaded. Since existing logistics-based technologies do not consider the varied parameters among different personal vehicles, they are inaccurate in calculating where packages should be placed in delivery vehicles. Additionally, designated delivery trucks and vans generally have readily accessible interiors (e.g., a cargo area lined with shelves) to allow relatively easy retrieval of a particular package, regardless of where it is located. By contrast, packages in a personal vehicle may need to be packed tightly such that packages on the bottom and near the driver or passenger seat may be difficult to access before other packages are unloaded. However, these existing logistics-based applications are unable to identify an optimal delivery configuration based on such constraints.

Moreover, these logistics-based technologies fail to account for various parameters to identify a particular location to place package, such as package route ID associated with a package, a trip number that indicates which trip a package will be delivered to a destination, and load area dimensions (e.g., height, width, and length). Accordingly, this causes these technologies to calculate area placement based on limited static information, thereby leading to inaccuracies.

Various embodiments of the present disclosure provide one or more technical solutions to these, and other, technical problems described above. For instance, particular embodiments improve immersive technologies. This is because these embodiments identify (or predict) an optimal (or suitable) configuration or indicate areas within a vehicle that assets should be placed, unlike existing immersive technologies. For example, various embodiments capture or map out the interior volume of a personal vehicle. Some of these embodiments responsively identify a configuration, among several configuration, such as placing a first package at particular coordinates on the floorboard of a personal vehicle after two additional packages have first been loaded. Responsively, for example, these embodiments can then cause a superimposition (e.g., an AR graphic) or indicia on an image of a real world cargo area of the coordinates, which indicates where the first package should be placed and in what order. Moreover, unlike existing immersive technologies, particular embodiments are not heavy and bulky because they are implemented via any suitable user device, such as a mobile phone. Accordingly, particular embodiments do not negatively affect the user experience (e.g., via obtrusive headsets) because the user is able to seamlessly navigate and perform tasks, such as loading a car, using a mobile phone.

Various embodiments also improve the capabilities of existing user devices, such as mobile phones. This is because various embodiments employ the sensors (e.g., a lidar-based camera) to map an interior of a vehicle and the functionality to identify and indicate areas within a vehicle that assets should be placed (e.g., an optimal configuration). Existing cameras in mobile phones, for example, are unable to map an interior volume of a vehicle to derive spatial parameter information, such as length, width, and height information of the vehicle’, as well as any real-time objects, such as seats, existing assets, and the like. Rather, these cameras only configured to capture a 2-dimensional image of a real world environment. However, particular embodiments are able to capture this interior volume information (e.g., via a lidar-based sensor) as well as predict or indicate (e.g., via computer vision functionality) the order the assets should be placed in the vehicle, unlike existing user devices.

Various embodiments improve the accuracy of existing logistics-based technologies because they are dynamic in the prediction or identification of where packages should be placed in delivery vehicles. For instance, these embodiments do not assume that cargo areas have regular shapes and sizes. Accordingly, various embodiments map out or consider varied parameters among personal vehicles, such as number of seating rows, the volume interior space associated with a floorboard, the surface area of a seat, and the like. Therefore, PVDs benefit from customized delivery configurations in real-time, based on the particular vehicle and the particular packages to be loaded. Because these embodiments consider the varied parameters among different personal vehicles, they are accurate in calculating where packages should be placed in specific delivery vehicles.

Additionally, particular embodiments are able to identify an optimal loading configuration notwithstanding packages in a personal vehicle being difficult to access because of accessibility limitations (e.g., only two doors) and because of the potential of extensively handling various assets to get the desired package. For example, if a delivery driver will arrive in a first area (e.g., a neighborhood) at a first stop (among many stops), particular embodiments can predict or identify each package that will be delivered to the first stop as needing to be placed near the cargo doors or next to the driver. This may take into account, for example, where the doors are located in a specific delivery vehicle. In this way, the delivery driver does not have to unnecessarily handle or parse through unrelated packages to get to the packages needing to be dropped off in the first area. Existing technologies do not provide for such optimization.

Moreover, particular embodiments improve the accuracy of logistics-based technologies by accounting for various parameters to identify a particular location to place a package. For example, particular embodiments consider a package route ID associated with a package, a trip number that indicates which trip will be delivered to a destination, and load areas (e.g., height, width, and length), which existing technologies do not consider. Accordingly, these embodiments identify an optimal delivery configuration based on more dynamic information relative to existing technologies, thereby improving the accuracy of these technologies.

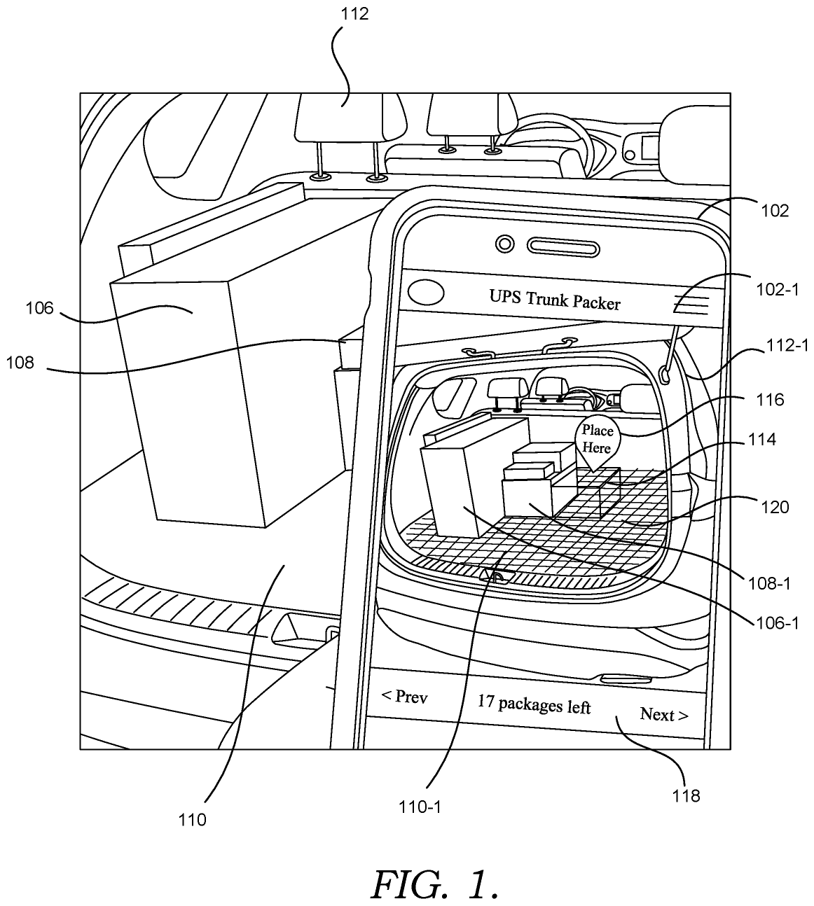

Turning now to the figures, FIG. 1 is a schematic diagram of augmented reality functionality to assist a user in loading a set of packages into a personal vehicle based on identifying an optimal loading configuration for the set of packages, according to some embodiments. As illustrated in FIG. 1, there is a real world personal vehicle 112, which is at least partially defined by a loading area or interior volume (i.e., trunk space) 110. The real world packages 106 and 108 have already been loaded into the loading area 110.

In order to assist the user in determining where the packages should be placed (and/or in what order), an application may be stored to the mobile device 102, which is responsible for assisting in identifying an optimal configuration for placing the packages within the loading area 110. In response to receiving an indication that the user has opened the application or has otherwise selected a feature at the application, particular embodiments automatically activate (or prompt the user to activate) a camera sensor (not shown) residing at an upper posterior or backside of the mobile device 102. In response to the activation of the camera and the camera being oriented towards the real world features (i.e., the personal vehicle 112, the interior volume 110, the package 106, and the package 108), the camera captures, via augmented reality functionality, the real world features and embodiments superimpose additional indicia, as illustrated by the display screen 102-1 of FIG. 1. Specifically, the display screen 102-1 includes data objects (e.g., pixel sets) 106-1 and 108-1, which respectively represent the real world packages 106 and 108. The display screen 102-1 further includes the data objects 112-1 and 110-1, which respectively represents the real world personal vehicle 112 and interior volume 110. In some embodiments, the data objects 106-1, 108-1 and/or any other feature on the display screen 102-1 is detected via object detection or computer vision functionality (e.g., via a Convolutional Neural Network (CNN), which is described in more detail below. In this way, particular embodiments can detect that particular assets have already been loaded into the loading area 110 and therefore generate loading instructions (e.g., the data object 114 or 116) based on what has already been detected in the loading area 110.

The display screen 102-1 further includes the data object 114 as well as the indicia 116 above the data object 114, which reads “place here.” These are AR indicators that are not present in the real world and have been superimposed over visual data representing the real world. These indicators are indicative of a prompt for the loading user to place a corresponding package (represented by the data object 114) into the exact orientation in dimensional space as indicated by the data object 114. Such indicators succeed or are a part of identifying an optimized configuration (e.g., a location and/or loading order) for a package represented by the data object 114. Identifying an optimized configuration is described in more detail herein.

The display screen 112-1 further includes the bottom ribbon 118, which reads “17 packages left.” This may indicate how many packages are left in the package array that need to be placed in the loading area 110. In some embodiments, the display screen 102-1 includes a user interface element (now shown), such as a drop down list of each of the 17 packages and corresponding identifiers (IDs) so that a user can identify the package. Such IDs can also be physically placed on the real world packages themselves to assist the user in placing the correct package into the optimal location and/or order of the optimal configuration. For example, the drop down menu may indicate that package ID 114 needs to be placed next and needs to be placed in the exact location, as represented by the data object 114. Subsequently, the user may physically locate (or read) the corresponding ID 114 on a real world package and physically place the package 114 into the exact coordinates, as illustrated by the data object 114 in the display 102-1.

The display screen 102-1 also includes a grid (i.e., horizontal and physical lines) 120, which indicates a mapping of the loading area 110 to capture the dimensions and/or existing real world object(s) located within the loading area 110. For example, some embodiments utilize computer vision or object detection functionality (e.g., a Convolutional Neural Network (CNN)) in order to detect existing objects located in the loading area 110. Alternatively or additionally, some embodiments use a range finder or other volumetric space determining tools (e.g., ARCore® or ARkit®) to capture the volumetric space in X, Y, and Z coordinates of the loading area 110. Such mapping and how it is used to assist in identifying an optimal configuration is described in more detail below.

Although FIG. 1 is described in terms of Augmented Reality (AR), alternative or additional immersive technologies may be used, such as Mixed Reality (MR) and/or Virtual Reality (VR). VR generates a fully artificial (non-real world) environment though it can represent the real world. In other words, users have a total artificial virtual experience. AR technologies overlay or superimpose virtual objects within the real world environment (or images that capture the real world environment). In other words, only some parts of the user experience are artificial while other parts reflect a real world environment. Accordingly, the real world is enhanced with these virtual objects. MR technologies not only overly virtual objects within the real world environment but users can interact with these virtual objects by making physical motions in the real world. For example, when a user makes a certain and gesture, a data object representing a package can be moved to a certain location.

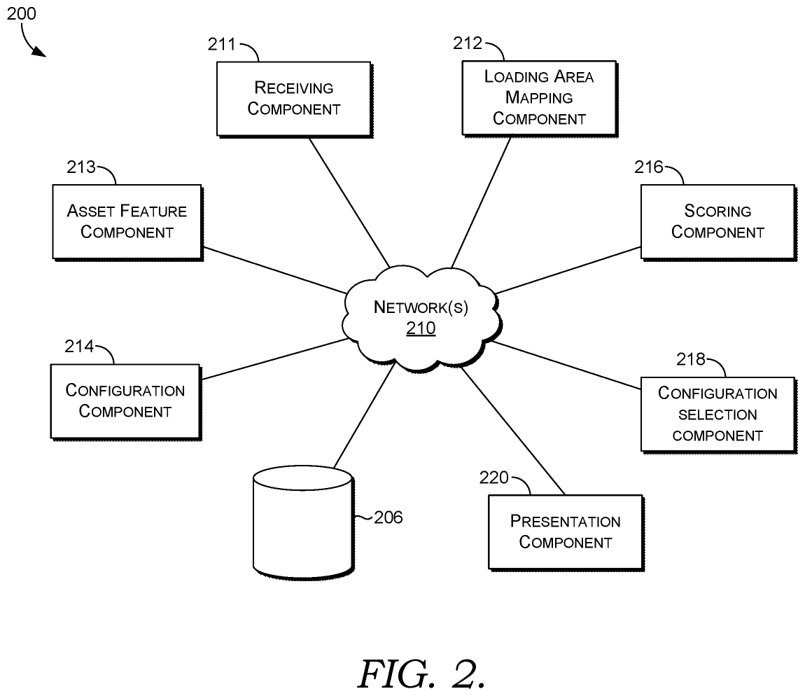

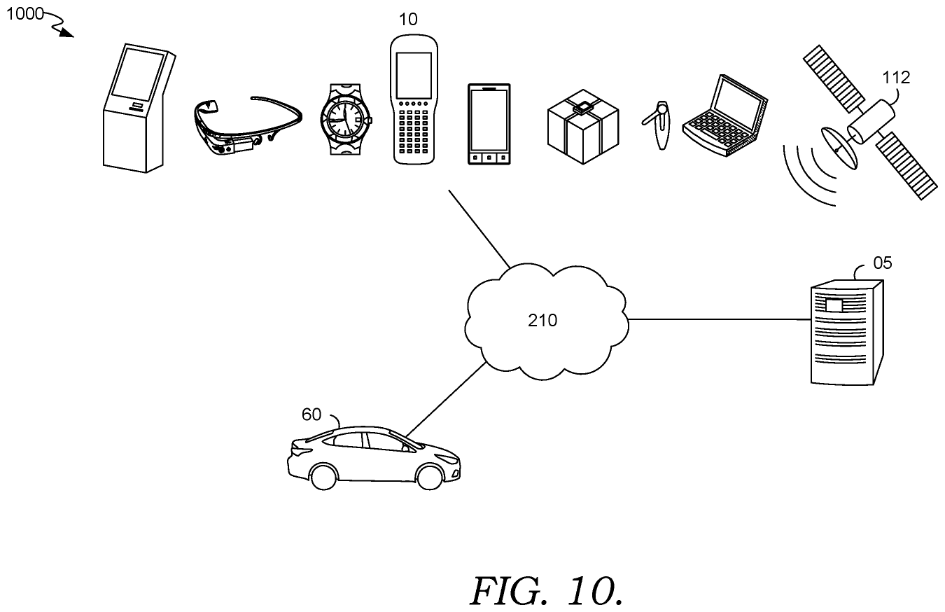

Referring now to FIG. 2, a block diagram is provided showing aspects of an example computing system architecture suitable for implementing some embodiments of the disclosure and designated generally as the system 200. The system 200 represents only one example of a suitable computing system architecture. Other arrangements and elements can be used in addition to or instead of those shown, and some elements may be omitted altogether for the sake of clarity. Further, many of the elements described herein are functional entities that may be implemented as discrete or distributed components or in conjunction with other components, and in any suitable combination and location. For example, some or each of the components of the system may be located within a single computing device (e.g., the computing entity 10 or the analysis computing entity 05 of FIG. 10). Alternatively, some or each of the components may be distributed among various computing devices, such as in a distributed cloud computing environment. In some embodiments, the components of the system 200 are distributed among the one or more computing entities 10 and/or the one or more analysis computing entities 05 of FIG. 10.

The system 200 includes network 210, which is described in connection to FIG. 10, and which communicatively couples components of system 200, including the receiving component 208, the loading area mapping component 212, the asset feature component 213, the configuration component 214, the scoring component 216, the configuration selection component 218, the presentation component 220, and storage 105 (e.g., RAM, a disk array, or a relational database). The components of the system 200 may be embodied as a set of compiled computer instructions or functions, program modules, computer software services, logic gates, or an arrangement of processes carried out on one or more computer systems.

The system 200 generally operates to identify an optimal (or suitable) configuration for placing one or more assets into a loading area and providing indications (e.g., via VR functionality) of such optimal configuration, according to some embodiments. The receiving component 211 is generally responsible for receiving a receiving a request for an optimized configuration for an asset array, where the asset array comprises a plurality of assets. An “asset” as described herein refers to any tangible item or set of items. For example, an asset may be a package, tools, equipment (e.g., a stroller), a machine, groceries, goods, a bag, or the like. In some embodiments, an asset is any item that is transported from one location to another. For example, an asset may be a package loaded from a sorting center to a loading area of a vehicle and may be removed from the vehicle and delivered to a final delivery (i.e., final mile delivery) destination, such as a residential/business address of a consignee. A sorting center is a facility where parcels are culled, labeled, and otherwise organized in preparation for final mile delivery. Assets may be or include the contents that enclose products or other items people wish to ship. For example, an asset may be or include a parcel, a package, a box, a crate, a drum, a container, a box strapped to a pallet, an envelope, a bag of small items, and/or the like. A “vehicle” as described herein refers to any suitable vehicle capable of propulsion, such as a delivery van, an aircraft, a drone, a boat, an Unmanned Aerial Vehicle (UAV), a truck, a tractor trailer, any of which can be autonomous, semi-autonomous, or not autonomous at all. A “delivery vehicle,” as described herein refers to any suitable vehicle used for one or more logistics or shipping operations, such as a standardized delivery vehicle (e.g., a UPS or other logistics delivery van, a logistics Unmanned Aerial Vehicle (UAV), a logistics tractor trailer, a logistics airplane), a personal vehicle, a freight vessel, or the like. A “personal vehicle” as described herein refers to any vehicle (e.g., a car or truck) that is not standardized or specifically built for logistics (e.g., shipping) operations, unlike standardized delivery vehicles. Standardized delivery vehicles are specifically built for logistics operations. Personal vehicles are typically owned by private individuals and used for multiple personal purposes, unlike standardized delivery vehicles, which are owned by logistics entities (e.g., UPS) and are used for the sole purpose of logistics operations.

In an illustrative example of receiving component 211 functionality, the receiving component 211 may receive an indication that a user has selected a button at a user interface indicative of a request to assist in determining a precise location and/or order for placing a package in a delivery vehicle.

The loading area mapping component 212 is generally responsible for determining one or more parameters associated with a loading area (e.g., a volume of space). In some embodiments, such parameters define the loading area and/or one or more objects located in the loading area. For example, the parameters may be the volumetric area (e.g., length, width, and height) of the open space of a vehicle trunk, where the volumetric area is the area of space between a surface area floorboard of the trunk, sidewalls of the vehicle, and a rooftop of the vehicle. For example, the parameters may define the loading area 110 of FIG. 1. In some embodiments, the one or more parameters alternatively or additionally define one or more objects located in the loading area. For example, the parameters that are detected may be one or more backrow seats, seatbelts, pre-existing assets, or the like within the loading area.

In some embodiments, the loading area mapping component 212 uses a Convolutional Neural Network (CNN) to recognize one or more parameters of the loading area or uses object detection functionality to detect real world objects located within the loading area. In an illustrative example of object detection functionality, particular embodiments use one or more machine learning models (e.g., a Convolutional Neural Network (CNN)) to generate a bounding box that defines the boundaries and encompasses a computer object representing a feature (e.g., a car seat, a steering wheel, a floorboard, a window, etc.) of the loading area. These machine learning models can also generate a classification prediction that the computer object is a particular feature. In computer vision applications, the output of object detection can be encompassed by a bounding box. A bounding box describes or defines the boundaries of the object in terms of the position (e.g., 2-D or 3-D coordinates) of the bounding box (and also the height and width of the bounding box). For example, the bounding box can be a rectangular box that is determined by its x and y axis coordinates. This gives object recognition systems indicators of the spatial distinction between objects to help detect the objects.

In some embodiments, one or more machine learning models can be used and trained to generate tighter bounding boxes for each object. In this way, bounding boxes can change in shape and confidence levels for classification/prediction can be increased based on increased training sessions. For example, the output of a Convolutional Neural Network (CNN) or any other machine learning model described herein can be one or more bounding boxes over each feature of an image (corresponding to each feature of a loading area), where each bounding box includes the classification prediction (e.g., this object is a car seat) and the confidence level (e.g., 90% probability).

Object detection or other machine learning model prediction using images can occur in any suitable environment. For example, mobile devices or headsets can be equipped with object detection cameras, where images of loading areas can continuously be streamed to buffer memory during the loading of assets such that the loading area mapping component 212 can determine, classify, or otherwise generate a decision statistic of each object within an image captured by the camera. In this way, the loading area mapping component 212 can learn the parameters of specific loading areas (e.g., for specific vehicles), as described in more detail below.

In an example illustration of how machine learning models can be used to classify images of loading areas or objects within images, one or more neural networks (e.g., CNNs) can be used. In some embodiments, various labeled images (e.g., of different vehicle loading areas) can first be identified and run through training, such as images that contain “car seat” “bench” or “mirrors.” The neural network can include a convolutional layer, a pooling layer, and a fully connected layer. The machine learning model neural network may be fed or receive as input one or more images of the loading area at the convolutional layer. Each input image can be transformed into a 2-D input vector array of values, such as integers of ones and zeroes. Each value represents or describes a particular pixel of the image and the pixel's intensity. For instance, each line or edge defining the trunk in the image can be denoted with a one and each non-line can be represented with zeroes. The convolutional layer utilizes one or more filter maps, which each represent a feature (e.g., a sub-image) of the input image of a loading area. There may be various features of an image and thus there may be various linearly stacked filter maps for a given image. A filter map is also an array of values that represent sets of pixels and weights where a value is weighted higher when it matches a corresponding pixel or set of pixels in the corresponding section of the input image. The convolution layer includes an algorithm that uses each filter map to scan or analyze each portion of the input image. Accordingly, each pixel of each filter map is compared and matched up against a corresponding pixel in each section of the input image and weighted according to similarity. In some embodiments, the convolutional layer performs linear functions or operations to arrive at the filter map by multiplying each image pixel value with its own value and then performing a summation function of each product, which is then divided by the total quantity of pixels in the image feature.

In particular embodiments, the pooling layer reduces the dimensionality or compresses each feature map by picking a window size (i.e., a quantity of dimensional pixels that will be analyzed in the feature map) and selecting the maximum value of all of the values in the feature map as the only output for the modified feature map. In some embodiments, the fully connected layer maps votes for each pixel of each modified feature to each classification or label (e.g., whether the feature is a “mirror” or “car seat,” etc.). The vote strength of each pixel is based on its weight or value score. The output is a score (e.g., a floating point value, where 1 is a 100% match) that indicates the probability that a given input image or set of modified features fits within a particular defined class (e.g., “window” “car seat,” or “stroller”). After the first picture is fed through each of the layers, the output may include a floating point value score for each classification type that indicates “car seat: 0.21,” “mirror: 0.70,” and “trunk floor board: 0.90,” which indicates that the particular feature within the image is trunk floor board, given the 90% likelihood. Training or tuning can include minimizing a loss function between the target variable or output (e.g., 0.90) and the expected output (e.g., 100%). Accordingly, it may be desirable to arrive as close to 100% confidence of a particular classification as possible so as to reduce the prediction error. This may happen overtime as more training images and baseline data sets are fed into the learning models so that classification can occur with higher prediction probabilities.

In some embodiments, the loading area mapping component 212 alternatively or additionally is or uses various sensors (e.g., a radar, LIDAR, a range finder, etc.) to map out a loading area. For example, the mapping can include a HD map that includes a real-time layer, a map priors layer, a semantic map layer, a geometric map layer, and a base map layer. In some embodiments, AR devices or mobile phones can be equipped with radar, LIDAR, or cameras where these sensor outputs can continuously be streamed to buffer memory, such that the loading area mapping component 212 can receive a map of the loading area. In this way, the loading area mapping component 212 can determine parameters of a particular loading area. In an illustrative example, in some embodiments, a single sensor or combination of sensors (e.g., a radar, a lidar, sonar, ultrasound, a range finder, and/or an object recognition camera) can generate a three-dimensional map of a loading area. In some embodiments, user devices, such as mobile phones, headsets, or the like contain one or more lidar sensors to perform mapping functionality. Lidar sensors are sensors that detect objects and build a map of a geographical environment based on transmitting a plurality of light pulses a second and measure how long it takes for those light pulses to bounce off of objects in the environment (e.g., loading area) back to the sensor (e.g., 150,000 pulses per second). These lidar units can indefinitely spin transversely, thereby capturing a 360-degree image of a vehicle and the loading area. The output is a three-dimensional mapping of the geographical environment. These sensors can also calculate the distance between itself and the objects within the environment, as well as detecting exact sizes, colors, shapes of objects, and/or other metadata.

In some embodiments, the loading area mapping component 212 alternatively or additionally functions based on user input or non-real-time functions. For example, in some embodiments, the loading area mapping component 212 prompts a user to select a vehicle make and model. Each vehicle make and model may be associated with maps of the corresponding loading area that have been predefined or predetermined prior to runtime or user requests to identify an optimized configuration. Accordingly, in response to receiving an indication that a user has selected a vehicle make and model, particular embodiments can access, from computer memory, the already-generated maps to determine the parameters of the loading area. In other example, the loading area mapping component 212 can receive direct user input of loading area dimensions, such as the length, width, and/or height that was typed by a user.

The asset feature component 213 is generally responsible for determining one or more asset features for each asset of a plurality of assets. For example, the asset feature component 213 can determine the length, width, height, volume, weight, and/or density of each asset. Such determination can be automated and/or based on user input. For example, in some automated embodiments, a processor executing the asset feature component 213 can automatically communicate, over the network(s) 210, with a database (e.g., the data store 105) of package manifests to obtain feature information from the package manifest. The term “package manifest” refers to a report provided by a shipper to a shipping service provider that summarizes the shipment information about the package that the shipper is going to provide to the shipping service provider. A package manifest may include the shipper's account information, shipping record identifier, dimensions of the package (e.g., length, width, and height) to be picked up/delivered, a planned package pick up time, a package pick up location, a shipping destination for an asset, package weight, and the like.

In yet another example of automated embodiments, a processor executing the asset feature component 213 can map the dimensions (e.g., length, width, and height) of an asset using any suitable sensor, such as a Lidar, radar, object detection camera, sonar, and/or any suitable sensor described above with respect to the loading area mapping component 212. In an example illustrated of user input embodiments, asset feature component 213 can receive an indication that a user has input different asset features, such as length, width, height, or indirect asset features, such as the destination location where each asset will be delivered to.

In some embodiments, the loading area mapping component 212 is used to determine the quantity of loading areas there are for a specific vehicle or facility. For example, object detection or other sensor-based mapping technology can map out the interior of a van and determine that there is a trunk, two rows of seats, and a passenger seat. Accordingly, various embodiments can then map each of these features to individual loading areas—the trunk is a first loading area, a first row of seats is a second loading area, a second row of sets is a third loading area, and a passenger seat is a fourth loading area for the same vehicle. Accordingly, each of these loading areas may be used to for loading arrangements and actual loading.

The configuration component 214 is generally responsible for generating or determining a plurality of configurations, where each configuration includes a set of loading area arrangements associated with placing or loading the plurality of assets into the loading area. A “loading arrangement” (or “loading area arrangement”) as described herein refers to an indication of a candidate order (e.g., load a first package, and then load a second package), a candidate location, a candidate orientation, a candidate loading area (e.g., is volume dimensions), and/or a candidate trip that a plurality of assets will be loaded in. For example, a first loading arrangement may be to load 4 packages into specific areas in a loading area, in a specific order, all during a first trip. A second loading arrangement may be to load the 4 packages into different loading locations and to split the loading of the packages into different trips (e.g., 2 packages during a first trop and 2 packages during a second trip). A “configuration” in some embodiments not only includes loading arrangements but particular delivery route(s) that the assets will be delivered in, the particular vehicle to be used for asset loading, the trip number, or the like.

In some embodiments, such configurations are based on the one or more parameters and/or the one or more asset features determined by the loading area mapping component 212 and the asset feature component 213. For example, if the asset features of a first set of packages indicate that they are arriving within a time and/or distance (e.g., neighborhood) threshold of each other and will be a part of a first stop (among many subsequent stops) of a route, then then particular embodiments may generate multiple loading arrangements (e.g., orientations and locations) where the first set of packages are placed next to each other and near the doors of a vehicle so that the unloading user can easily access the first set of packages at the first stop. Such pattern can continue with a second set of packages, where the second set of packages are arriving within a time and/or distance threshold of each other and are part of a second stop directly subsequent to the first stop. Accordingly, a second set of loading arrangements for the second set of packages may require that the second set of packages be placed immediately behind the first set of packages such that the first set of packages are between the second set of packages (which are oriented more towards the center of the vehicle) and the door. In some embodiments, the configuration component 214 uses one or more machine learning models, as described in more detail below.

The scoring component 216 is generally responsible for scoring (e.g., via an integer value), assigning a score, or otherwise determining a score to each configuration of the plurality of configuration generated by the configuration component 214. In some embodiments, the higher the score, the higher the ranking or the more optimal or suitable the configuration is for selection by the configuration selection component 218.

In some embodiments, the score is based on the one or more parameters and/or the one or more asset features determined by the loading area mapping component 212 and the asset feature component 213. For example, in some embodiments, the scoring component 216 determines scores based on asset dimension (e.g., length, width, height), asset weight, package route ID (indicating which route a particular asset will be delivered in), trip number (indicating which trop the asset will be loaded in a particular load area if it is determined that all assets cannot be loaded in the same trip), load area parameters (e.g., length, width, height, detected objects, and load area IDs (e.g., each vehicle may have more than one load area).

In some embodiments, the score generated by the scoring component 216 is generated based on an aggregation or combination individual sub-scores for each feature and parameter, where each feature or parameter score is based on how well the individual configuration is suitable for the particular feature and parameter. In an illustrative example, if a first asset's weight was heavier than all other assets, a first configuration included a loading arrangement may be to place the first asset on the floor of a vehicle and the second configuration included a second loading arrangement may be to place the first asset on top of another asset (and not the floor). The “weight” feature for the first configuration would be scored higher (e.g., 3) compared to the same feature score (e.g., 1) for the second configuration. This may be based on a programmatic rule (e.g., a conditional statement) that indicates that heavier packages (e.g., greater than a threshold weight) should be placed on the floor so that they do not crush other packages. If that criteria is met, then a particular score is assigned. Continuing with this example, if a floor board loading area of a vehicle was had a X dimension surface area, the first configuration may be to place the first asset (slightly smaller than X dimension) at the floor board and the second configuration may be to place the first asset at another location in a vehicle, where the surface area is much larger than X dimension. The “package dimension” or “surface area dimension” feature for the first configuration would be scored higher (e.g., 5) compared to the same feature score (e.g., 2) for the second configuration. This may be based on another programmatic rule that indicates packages should be slightly smaller (e.g., fit within an inch threshold) than the surface area it will be placed on. Accordingly, the final score may be to add up each sub-score for each of the two configurations—add up the 3 and 5 for the second configuration (8) and add up the 1 and 2 score for the first configuration (3). Because 8 is higher than 3, the second configuration is ranked or scored higher.

In some embodiments, each sub-score or score is weighted (e.g., by adding an integer value to an already-calculated sub-score) based on the importance of a feature or parameter. For example, programmatic logic may indicate that a value of 3 should be added to any weight score and no weight score should be added to a dimension score, which is indicative that weight is relatively more important for loading arrangements.

In some embodiments, the scoring determined by the scoring component 216 is alternatively or additionally the result of or part of machine learning functionality. For example, the score can be or include a confidence level interval for a classification, clustering, or regression prediction made by a model. For example, a model may predict, for a first configuration and with 90% confidence, a particular asset belongs in a particular location and/or orientation in a loading area, compared to a second configuration and a 75% confidence that the particular asset belongs in a different location and/or orientation. In these embodiments, the first configuration would be scored higher based on the confidence level being higher than the second configuration. Alternatively or additionally, the scoring determined by the scoring component 216 is directly proportional to the distance (e.g., Euclidian, Cosine, or Hamming) between feature vectors processed by machine learning models. Machine learning functionality is described in more detail below.

The configuration selection component 218 is generally responsible for selecting or identifying one or more configurations, among the plurality of configurations, based on the corresponding score(s) determined by the scoring component 216. For example, using the illustration above, in some embodiments, the configuration selection component 218 selects the second configuration because its score of 8 is higher than the first configuration's score of 1.

In some embodiments, the configuration selection component 218 selects or identifies a single configuration based on the configuration being the most optimal, where “optimal” means that the configuration has the highest score. In alternative embodiments, the configuration selection component 218 selects or identifies the configuration based on the configuration being a suitable configuration (without necessarily being the most optimal). In this way, for example, the selected configuration need not be the highest scoring configuration (e.g., because a user prefers this configuration). In yet other embodiments, the configuration selection component 218 selects multiple configurations. For example, in some embodiments, a processor executing the configuration selection component 218 can select the 3 highest ranked/scored configurations (among 20 ranked configurations) for display via the presentation component 220.

In some embodiments, the configuration selection component 218 additionally generates one or more instructions for loading the plurality of assets in to the loading area(s) (e.g., of a delivery vehicle) in accordance with the set of loading area arrangements or configurations selected/identified by the configuration selection component 218. Such “instruction” may be a prompt, command (e.g., a natural language command), and/or visual indicator (e.g., the superimposed data object 114 of FIG. 1) to the user to place or load an asset in a particular location, orientation, and/or a particular order relative to other assets. For example, using the illustration above, the selected second configuration may be a configuration where a first asset is placed at a floorboard loading area of a first vehicle, and a second asset is stacked on top of the first asset. Accordingly, the loading instructions may be for the user to first place the first asset at the floorboard loading area of the first vehicle. Then the loading instructions may be for the user to place the second asset on top of the first asset. Accordingly, such loading instructions, when followed by the user, match or conform to the selected configuration(s). In another example of loading instructions with respect to FIG. 1, these include the indication of the specific placement and orientation of the data object 114 and the “place here” indicia 116.

In some embodiments, a configuration selected by the configuration selection component 218 represents or indicates what configuration has been selected by the user so that loading instructions can be provided to a user device based on this selection. In some embodiments, one or more selections selected by the configuration selection component 218 represents what is recommended and provided to a user so that the user can then make a selection. In some embodiments, a configuration selected by the configuration selection component 218 represents the configuration automatically selected (without user input) for providing loading instructions to the user.

The presentation component 220 is generally responsible for presenting content (or causing presentation of content) and related information to a user, such as the loading instructions described with respect to the configuration selection component 218. Presentation component 220 may comprise one or more applications or services on a user device, across multiple user devices, or in the cloud. For example, in one embodiment, presentation component 220 manages the presentation of content to a user across multiple user devices associated with that user. Based on content logic, device features, and/or other user data, presentation component 220 may determine on which user device(s) content is presented, as well as the context of the presentation, such as how (or in what format and how much content, which can be dependent on the user device or context) it is presented, when it is presented. In particular, in some embodiments, presentation component 220 applies content logic to device features, or sensed user data to determine aspects of content presentation.

In some embodiments, presentation component 220 generates (or causes generation of) user interface features. Such features can include interface elements (such as graphics buttons, sliders, menus, audio prompts, alerts, alarms, vibrations, pop-up windows, notification-bar or status-bar items, in-app notifications, or other similar features for interfacing with a user), queries, and prompts. For example, the presentation component 220 can cause presentation of a list of ranked configurations, each of which are selectable by a user so the user can visualize each configuration.

In some embodiments, the presentation component 220 additionally or alternatively generates or causes presentation of immersive technology components based on the functionality performed by the configuration selection component 218. For example, in some embodiments, the presentation component 220 is responsible for generating contents located at the display screen 102-1 of FIG. 1. In other words, for example, in some embodiments the presentation component 220 is responsible for generating images that reflect the real world and/or virtual elements that are superimposed over the images, such as the data object 114, which is superimposed over an image of the loading area 110 of FIG. 1.

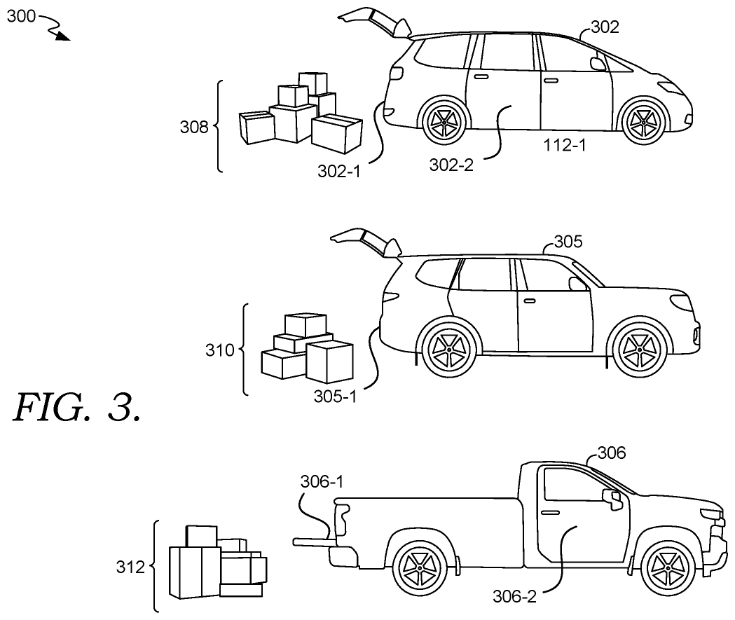

FIG. 3 is a schematic diagram illustrating different personal vehicles and package arrays that must be loaded into one or more respective loading areas, according to some embodiments. It is understood, however, that the functionality described with respect to FIG. 3 may additionally or alternatively apply to any delivery vehicle (e.g., a standard package car), as described herein. As illustrated in FIG. 3, each personal vehicle 302, 305, and 306 are different vehicles, such as different makes, models, or types (e.g., trucks, vans, SUVs). Accordingly, the quantity of loading areas and the loading area volumetric dimensions may be different relative to each other. This is different than conventional logistics tractor trailers or logistics vans that have basic or similar loading area volumetric dimensions (e.g., a single rectangular prism of a particular size). Accordingly, various embodiments use the loading area mapping component 212 to map out the interiors of the personal vehicles 302, 305, and 306 in order to select or identify, via the configuration selection component 218, a configuration for loading corresponding assets.

In an illustrative example, a first optimal configuration may be selected to load a portion of the asset array 308 into the loading area 302-1 (the trunk) and another portion of the asset array 308 into the loading area 302-2 (a row of seats) of the personal vehicle 302 (e.g., a van). In another example, a second optimal configuration may be selected to load each asset of the asset array 310 into the loading area 305-1 (the trunk) of the personal vehicle 305 (e.g., a SUV). In yet another example, a third optimal configuration may be selected to load a portion of the asset array 312 into the loading area 306-1 (the bed) and another portion of the asset array 312 into the loading area 306-2 (the passenger seat) of the personal vehicle 306 (e.g., a truck).

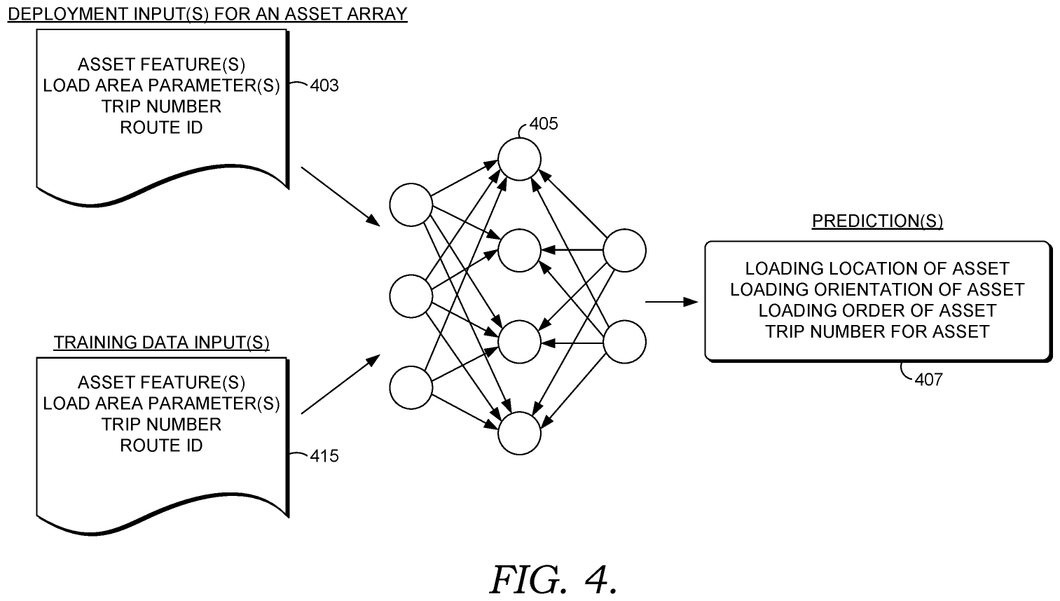

FIG. 4 is a schematic diagram illustrating the potential inputs fed to a neural network (or other machine learning models) to generate predicted inferences, in accordance with embodiments of the present disclosure. In one or more embodiments, a neural network 405 represents or includes at least some of the functionality as described with respect to the configuration component 214 and/or the scoring component 216.

In various embodiments, the neural network 405 is trained using one or more data sets of the training data input(s) 415 in order to make training predictions (407) or inferences (407) later at deployment time via the deployment input(s) 403. In one or more embodiments, learning or training can include minimizing a loss function between the target variable (e.g., a ground truth loading location) and the actual predicted variable (e.g., the predicted loading location after a first training epoch). The target variable or ground truth can be or include any suitable attribute or set of attributes, such as a ground truth loading location, a ground truth orientation, a ground truth loading order, and/or a ground truth trip number. Based on the loss determined by a loss function (e.g., Mean Squared Error Loss (MSEL), cross-entropy loss, etc.), the loss function learns to reduce the error in prediction over multiple epochs or training sessions so that the neural network 405 learns which features, weights, or embeddings are indicative of the correct predictions, given the inputs. Accordingly, it may be desirable to arrive as close to 100% confidence in a particular classification or inference as possible so as to reduce the prediction error. In an illustrative example, the neural network 405 can learn over several epochs that for a given asset or asset array with specific features indicated in the training data input(s) 415, the likely loading location will be a specific X, Y, Z, coordinate, the orientation will be to lay an asset on a particular side, the asset will be loaded in a particular order after or before other assets, and the asset will be a part of a specific trip.

Subsequent to a first round/epoch of training (e.g., processing the “training data input(s)” 415), the neural network 405 may make predictions 407, which may or may not be at acceptable loss function levels relative to the ground truth. For example, the neural network 405 may process an asset that is a particular length, width, and height, and the prediction at the first epoch may be that this asset should be placed in a loading location that is smaller than the length, width, and height of the asset. Such prediction may thus produce an unacceptable loss. Accordingly this process may then be repeated over multiple iterations or epochs until the optimal or correct predicted value(s) is learned and/or the loss function reduces the error in prediction to acceptable levels of confidence. For example, using the illustration above, the neural network 405 may learn that the correct loading location for the asset is an area that is slightly larger than the width, height, and length of the asset so as to fit snugly, which produces an acceptable level of confidence.

In one or more embodiments, the neural network 405 converts or encodes the runtime input(s) 403 and training data input(s) 415 into corresponding feature vectors in feature space (e.g., via a convolutional layer(s)). A “feature vector” (also referred to as a “vector”) as described herein may include one or more real numbers, such as a series of floating values or integers (e.g., [0, 1, 0, 0]) that represent one or more other real numbers, a natural language (e.g., English) word and/or other character sequence (e.g., a symbol (e.g., @, !, #), a phrase, pixels, and/or sentence, etc.). Such information corresponds to the set of features and are encoded or converted into corresponding feature vectors so that computers can process the corresponding extracted features. For example, embodiments can generate a feature vector that represents each feature (e.g., length, width, height, delivery location, delivery time, route ID) of an asset or asset array. Some embodiments can generate another feature vector that represents each parameter (e.g., length, width, height, detected objects, load area ID) of a loading area or multiple loading areas (e.g., within a single vehicle).

In one or more embodiments, the neural network 505 learns, via training, parameters, or weights so that similar features are closer (e.g., via Euclidian or Cosine distance) to each other in feature space by minimizing a loss via a loss function (e.g. Triplet loss or GE2E loss). Such training occurs based on one or more of the training data input(s) 415, which are fed to the neural network 405. One or more embodiments can determine one or more feature vectors representing the input(s) 415 in vector space by aggregating (e.g. mean/median or dot product) the feature vector values to arrive at a particular point in feature space. For example, certain embodiments can formulate a dot product of the asset feature vector and the loading area feature vector and then aggregate these values into a single feature vector so that each feature and parameter is represented in the feature vector.

In one or more embodiments, the neural network 405 learns features from the training data input(s) 915 and responsively applies weights to them during training. A “weight” in the context of machine learning may represent the importance or significance of a feature or feature value for prediction. For example, each feature may be associated with an integer or other real number where the higher the real number, the more significant the feature is for its prediction. In one or more embodiments, a weight in a neural network or other machine learning application can represent the strength of a connection between nodes or neurons from one layer (an input) to the next layer (an output). A weight of 0 may mean that the input will not change the output, whereas a weight higher than 0 changes the output. The higher the value of the input or the closer the value is to 1, the more the output will change or increase. Likewise, there can be negative weights. Negative weights may proportionately reduce the value of the output. For instance, the more the value of the input increases, the more the value of the output decreases. Negative weights may contribute to negative scores.

In another illustrative example of training, one or more embodiments learn an embedding of feature vectors based on learning (e.g., deep learning) to detect similar features between training data input(s) 415 in feature space using distance measures, such as cosine (or Euclidian) distance. For example, the training data input 415 is converted from string or other form into a vector (e.g., a set of real numbers) where each value or set of values represents the individual features (e.g., asset features and loading area parameters) in feature space. Feature space (or vector space) may include a collection of feature vectors that are each oriented or embedded in space based on an aggregate similarity of features of the feature vector. Over various training stages or epochs, certain feature characteristics for each target prediction can be learned or weighted. For example, for assets of a particular dimension in the training input(s) 415, the neural network 405 can learn that assets at this particular dimension is consistently placed in an X dimension loading area, directly on the floor board, and at a particular orientation. Consequently, this pattern can be weighted (e.g., a node connection is strengthened to a value close to 1, whereas other node connections (e.g., representing other fields) are weakened to a value closer to 0). In this way, embodiments learn weights corresponding to different features such that similar features found in inputs contribute positively for predictions.

In some embodiments, such training is supervised using annotations or labels. Alternatively or additionally, in some embodiments, such training is not-supervised using annotations or labels but can, for example, include clustering different unknown clusters of data points (e.g., asset feature-location area pairs) together. In an illustrative example of supervised learning, a document indicating asset or asset array features (e.g., length, width, height) may be labeled with a particular location that indicates the ground truth location area attributes (e.g., loading location, orientation, loading order, trip number) for the given features of the asset or asset array. For example, a document indicating a particular weight and dimensions of an asset may be labeled with a particular ground truth loading location, such as on the bottom and at a particular orientation within the loading location. In other words, the documents with these labeled pairs represent the ground truth (e.g., the target variable) for predictions in order to derive and assess loss via a loss function. In this way, for example, whenever features of an asset match or are within a distance to this asset particular embodiments aim to reduce loss such that these embodiments predict that the loading location will be at the bottom and orientation based on what the model derives from the ground truth.

Alternatively or additionally, in some embodiments, training is based on users interacting in a VR environment. In these embodiments, users input actions act as the annotation or labelling agents that establish what the ground truth loading area parameters (e.g., loading location, loading orientation, loading order, and trip number) are for given asset features. For example, an interactive simulated stacking game or application may be rendered to users where users can interact, via a user interface, with assets that are labeled with specific features by virtually placing thee logical assets in particular locations, orientation, and/or loading locations. For example, for a user may drag a data object representing an asset with particular features (e.g., length, width, weight) to another data object representing a particular loading area with particular features (e.g., length, width, height). The user may also orient the data object in a particular orientation. The user, or several users, may do the same to various assets with differing parameters. In this way, the ground truth loading location, orientation, loading order, and the like can be determined for given assets.

Alternatively or additionally, in some embodiments, training is based on monitoring real world user interactions in a real world environment. For example, with user permission, some embodiments use a camera to capture several users physically loading several assets into several loading areas or vehicles. Labelling or annotating can be based on where, within a loading location or vehicle, users have loaded each asset, the orientation that the user has placed the assets in, the order the user has placed the assets in, and/or the trip number for the asset. For example, embodiments can label a package manifest that includes asset features associated with an asset with the loading location, the orientation, the order, and/or trip number indicative of how the asset was physically loaded by the user. In some embodiments, such loading location, orientation, order and/or trip number can be determined via a separate model itself, such as an object detection model or image-processing model (e.g., a CNN), as described above with respect to the loading area mapping component 212.

Alternatively or additionally, in some embodiments, training is based on using reinforcement learning to train the neural network 405. In other words, the neural network 405 may represent a reinforcement learning model to find the optimal configuration (e.g., the configuration selected by the configuration selection component 218). In reinforcement learning, an agent finds the best possible path to reach a reward (e.g., a certain score or amount of points). In some embodiments, the reward is given for maximizing a score (e.g., the score produced by the scoring component 216) or more precisely, generating or selecting configurations whose scores meet or are over a threshold. Accordingly, in these embodiments, the reinforcement model may only give a reward for scores over a threshold. For example, some embodiments give 5 reward points for each configuration score over 10. One or more embodiments impose a penalty for any scores that fall below or otherwise do not meet a score threshold. For example, using the illustration above, if a configuration score was 9 or below, there may be a penalty issued, such as a reduction of 4 reward points from the currently accrued rewards. Such process continues or iterates until the optimal or suitable configuration is generated with the highest score (or score above a threshold) by maximizing the points or other rewards offered by the reinforcement learning model.

Alternatively or additionally, in some embodiments, the neural network 405 engages in a game similar to reinforcement learning in order to find the most optimal configuration. In these embodiments, the neural network 405 emulates user input by using, for example, UNITY ML agents, which use TENSORFLOW to play a game by automatically stacking or placing assets in three dimensions. The goal of the game is to stack or place the data objects representing assets in a data object representing a loading location so as to obtain the highest score. In this way, these agents perform several different simulations by virtually loading data objects representing assets into other data objects representing loading areas according to several configurations until an optimal score is obtained. The neural network 405 responsively learns and understands what the ground truth is according to the highest score. In an illustrative example of a game, the model may place two packages that are delivered at the same route together in the same vehicle but in two different loading areas, which is 1 point. Another game may include placing the two same packages immediately next to each other in the same loading area, which may be an additional 4 points. And yet another game may be to split up these two packages into different vehicles, which is zero points. Accordingly, the optimal simulation may be to place two packages immediately next to each other in the same loading area because the agent receives the highest score—4 points—relative to the other simulations. In some embodiments, such score values are determined based on programmatic rules or learning what users do over time (e.g., the more often users place a particular asset with particular features in a given loading area, the higher the score will be).

Continuing with FIG. 4, in one or more embodiments, subsequent to the neural network 405 training, the machine learning model(s) 405 (e.g., in a deployed state) receives one or more of the deployment input(s) 403. When a machine learning model is deployed, it has typically been trained, fine-tuned, tested, and packaged so that it can process data it has never processed. Responsively, in one or more embodiments, the deployment input(s) 403 are automatically converted to one or more feature vectors and mapped in the same feature space as vector(s) representing the training data input(s) 415 and/or training predictions). Responsively, one or more embodiments determine a distance (e.g., a Euclidian distance) between the one or more feature vectors and other vectors representing the training data input(s) 415 or predictions, which is used to generate one or more of the predicted inferences 407.

For example, if the deployment input(s) 403 indicate that together the assets are X dimensions, and that a floorboard loading area is X dimensions (values in the feature vector), the model 405 may predict that the optimal loading area is the floorboard based on training where this was deemed to be an acceptable prediction (e.g., within a loss threshold) for this particular input according to the ground truth. Therefore, because the neural network 405 has already learned the optimal loading location for this (or a similar input), it makes the same prediction at deployment time. In certain embodiments, the predicted inference(s) 407 may either be hard (e.g., membership of a class is a binary “yes” or “no”) or soft (e.g., there is a probability or likelihood attached to the labels). Alternatively or additionally, transfer learning may occur. Transfer learning is the concept of re-utilizing a pre-trained model for a new related problem (e.g., a new video encoder, new feedback, etc.).

As illustrated by the deployment input(s) 403, the training data input(s) 415, and the predicted inferences 407, there may be any suitable combination of data and predictions to process. For example, per the training data input(s) 415, the neural network 405 may train on one or more asset features, one or more load area parameters, a load area ID, and/or a route ID. In this way, when the same (or similar) values are captured per the deployment input(s) 403, the neural network 405 can make specific predictions per 407, given the training. For example, given asset feature(s), load area parameter(s), load area ID, and/or route ID of the deployment input(s) 403, the model 405 can predict, based on the training, loading location for each asset in the asset array, the loading orientation for each asset in the array, the loading order of each asset in the array, and/or a trip number for each asset (e.g., whether to split up delivery of assets into multiple trips), as indicated in the prediction(s) 407.

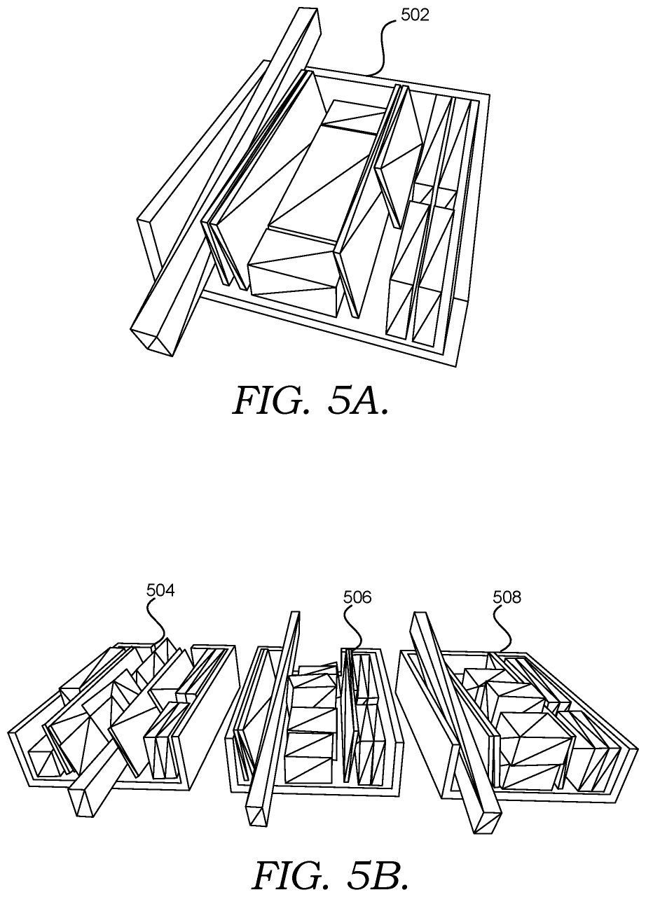

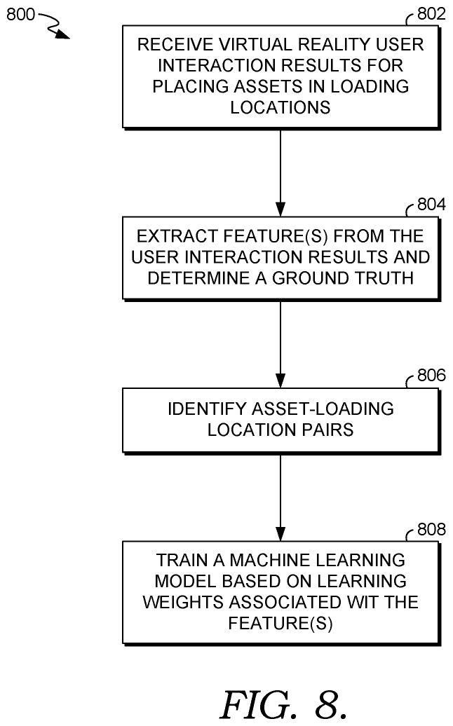

FIG. 5A is a schematic diagram of a virtual simulation illustrating a single load area 502 and assets for learning one or more optimal configurations, according to some embodiments. In some embodiments, FIG. 5A (and FIG. 5B) represents what users visualize and interact with when they place virtual assets in virtual loading locations for training a model, as described with respect to FIG. 4 and block 802 of FIG. 8. In other words, the load areas of FIG. 5A and FIG. 5B can be caused to be presented or displayed at a user device to users so that the users can place (e.g., drag) differently sized virtual assets into corresponding virtual loading locations, which represents the ground truth. FIG. 5B is a schematic diagram of a virtual simulation illustrating multiple load areas 504, 506, and 508 for learning one or more optimal configurations, according to some embodiments. In a given vehicle or other facility, there may be more than one loading area, such as in a passenger seat, a passenger floorboard, a trunk, a bench seat behind the passenger and driver seats, a floorboard in front of such bend seat, and the like. Accordingly, a model may learn how users place particular assets in particular load areas of a particular vehicle or facility.

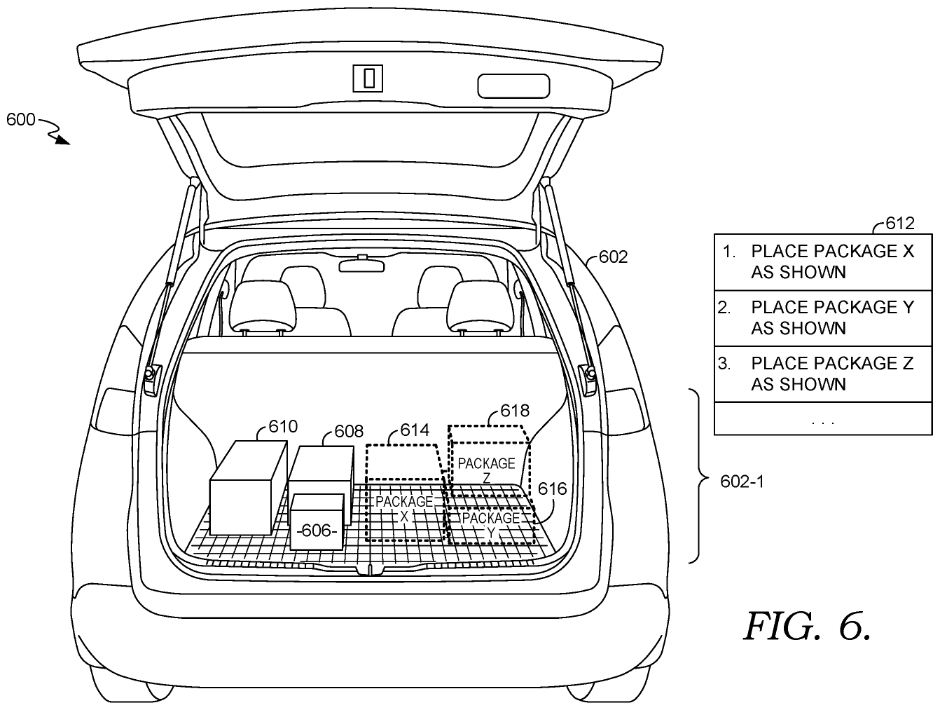

FIG. 6 is a screenshot 600 of an immersive technology interface, according to some embodiments. In some embodiments, the presentation component 220 is responsible for causing presentation of the screenshot 600. In some embodiments, the screenshot 600 represents what is viewed by a user wearing an immersive technology headset or other wearable device. In some embodiments, such wearable device can alternatively be a chest-mounted, wrist band, or other device with a laser projector and/or depth sensors to project the screenshot 600 (or elements within the screenshot 600). A laser projector is a device that projects changing laser beams on a screen to create a moving image. A depth sensor is a three-dimensional range finder, which means they acquire multi-point distance information across a wide Field-of-View (FoV).

In some of these embodiments, the screenshot 600 represents a mixture of real-world features as well as virtual objects. For example, the vehicle 602, and the packages 610, 608, and 606 may all be real world objects. Conversely, in these embodiments, the data objects 614, 616, and 618, as well as loading instructions 612 may all be virtual objects, such as AR objects superimposed over real world objects. However, in other embodiments, all of the content within the screenshot 600 represents an image (e.g., a digital photograph) or virtual representation of the real world, with virtual data objects (e.g., 614, 616, 618, and 612) overlaying or superimposed over the image.

The Screenshot 600 includes the vehicle 602 and the loading instructions 612. The vehicle 602 further includes the loading area 602-1, and the loading area 602-1 further includes the packages 606, 606, 610, as well as the data objects 614, 616, and 618 (which can also be considered loading instructions). Each of these data objects represent packages that have not yet been physically loaded into the loading area 602-1.

The screenshot 600 illustrates how immersive technology can be used to assist the user, via loading instructions, to load real-world packages into the vehicle 602. For example, at a first time (e.g., after the configuration selection component 218 determines the optimal configuration) a loading user may physically load the packages 606, 608, and 610 into their respective orientations and locations according to the optimal configuration, as depicted in FIG. 6. Subsequently, particular embodiments (e.g., a processor executing the presentation component 220) may provide loading instructions to load the rest of the packages corresponding to data objects 614, 616, and 618. The loading instructions 612 depict a step-by-step process for the user load packages according to the optimal configuration selected by the configuration selection component 218. For example, the loading instructions 612 render instructions for the user to first place package X in the location and orientation as illustrated by 614. Particular embodiments further instruct the user to place package Y in the location and orientation as illustrated by 616 after the user has placed package X in its designated area. Particular embodiments also instruct the user to place package Z to the location and orientation represented by 618 (i.e., on top of package Y) after loading package Y into its appropriate location. Such process can continue until all packages in the array are loaded.

Some embodiments make dynamic predictions in real-time based on the location and orientation a user has placed particular assets. For example, after the user has physically placed the packages 610, 608, and/or 610 into the locations as illustrated in FIG. 6, a processor executing the loading area mapping component 212 can continuously map out the loading area 602-1 to continuously detect objects and the exact location of objects. In some embodiments, such real-time placement dictates what the next loading instruction will be. This is because in some instances, users do not necessarily load assets according to the recommended or optimal configuration. Instead, they may physically place an asset in an area slightly different (e.g., outside of a distance threshold) than the optimal recommendation or ignore the recommendation altogether. Accordingly, the configuration selection component 218 can perform functionality in an iterative manner depending on what real-time objects are detected in the loading area 602-1. For example, in response to detecting, via computer vision functionality, that the user has placed the package 606 in its current location (instead of the optimal location where data object 616 is), particular embodiments change scores and/or the selected configuration (via the scoring component 216 and configuration selection component 218) to make a new optimal configuration recommendation and therefore new loading instructions based on the asset features, loading area parameters (e.g., loading areas left), as described above.

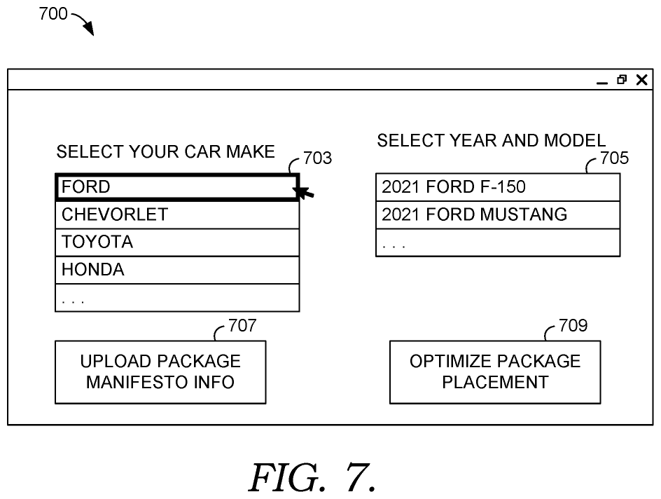

FIG. 7 is a screenshot 700 of an example user interface for identifying an optimal delivery configuration, according to some embodiments. In some embodiments, the screenshot 700 represents what is caused to be presented to via the presentation component 220 of FIG. 2. In some embodiments, the screenshot 700 represents functionality provided to a user to help the loading area mapping component 212 and the configuration selection component 218 perform their respective functions, according to some embodiments.

The screenshot 700 includes a first user interface element 703 (e.g., a drop down menu), a second user interface element 705 (another drop down menu), a user interface button 707 and the user interface button 709. Each of these features assist the configuration selection component 218 perform its functionality. Specifically, user input provided at the user interface elements 703 and 705 indicate loading area parameters to be determined by the loading area mapping component 212. Similarly, user selection of the button 707 retrieves feature assets to be determined by the asset feature component 213. And user selection of the button 709 causes the configuration component 214, the scoring component 216, and the configuration selection component 218 to perform its functionality.

In an illustrative example, as depicted in the screenshot 700, particular embodiments first receive an indication that the user has selected a “FORD” make indicia via the user interface element 703. Subsequently, particular embodiments receive an indication that the user has selected the “2021 Ford F-150” model indicia via the user interface element 703. In response to receiving the indication of the selection made at user interface element 703, particular embodiments automatically access (e.g., send a request over the network(s) 110) a data store (e.g., the data store 105), which includes corresponding maps or parameters of corresponding loading areas. For example, the data store can include a hash map or lookup table, where the keys are the model or make of the vehicle selected via the UI elements 703 and 705. Accordingly, when access of the data store occurs, embodiments use these elements as keys to retrieve the corresponding map or parameter information (e.g., the map generated by the loading area mapping component 212). In this way, such maps or parameters may have already been predefined or predetermined before runtime of an application that runs the screenshot 700. Accordingly, for example, a processor executing the loading area mapping component 212 can determine that the selected “2012 Ford F-150” has 3 loading areas of X dimensions.

Continuing with the illustrative example above, some embodiments receive an indication that the user has selected the button 707. In response to receiving such indication, particular embodiments cause presentation of operating system dialogue boxes or other elements so that the user can upload package manifests, in order to capture asset feature information, such as package weight, height, length, delivery route information, and the like for an asset array to be delivered to multipole locations. Subsequent to receiving an indication that the user has therefore uploaded or selected both asset feature information and loading area parameter information, an optimal configuration can then be determined. For example, in response to receiving an indication that the user has selected the button 709, a processor executes the configuration component 214, the scoring component 216, the configuration selection component 218, and the presentation component 220 based on information the user provided via the UI elements 703, 705, and 707.

Subsequent to selecting a suitable configuration based on information input at the screenshot 700, some embodiments, such as a processor executing the presentation component 220, cause presentation of indicia similar to the display 102-1 of FIG. 1 and/or the screenshot 500 of FIG. 5. In this way, the user can be provided with loading instructions for how to load, in the 2021 Ford F-150, an asset array as indicated via the button 707 in a suitable configuration.

FIG. 8 is a flow diagram of an example process 800 for training a machine learning model, according to some embodiments. The process 800 (and/or any of the functionality described herein, such as 900) may be performed by processing logic that comprises hardware (e.g., circuitry, dedicated logic, programmable logic, microcode, etc.), software (e.g., instructions run on a processor to perform hardware simulation), firmware, or a combination thereof. Although particular blocks described in this disclosure are referenced in a particular order at a particular quantity, it is understood that any block may occur substantially parallel with or before or after any other block. Further, more (or fewer) blocks may exist than illustrated. Added blocks may include blocks that embody any functionality described herein (e.g., as described with respect to FIG. 1 through FIG. 12). The computer-implemented method, the system (that includes at least one computing device having at least one processor and at least one computer readable storage medium), and/or the computer readable medium as described herein may perform or be caused to perform the process 800 or any other functionality described herein.

Per block 802, particular embodiments receive virtual reality user interaction results for placing assets in loading locations. Examples of this are described with respect to the neural network 405 of FIG. 4 and FIG. 5. For example, particular embodiments render a virtual environment or game where various users are given various assets and the users are prompted to place each asset in the location where the users thinks fits best in a vehicle. Accordingly, the users may drag each data object representing differently sized assets into other data objects representing different loading locations of different vehicles. The users may choose the exact X, Y, Z coordinates, the orientation, the order of placement, and the like. Each asset may have differing predetermined features (e.g., route number, destination location, etc.), for which the users are aware. In some embodiments, such users are delivery drivers that are trained in package placement so that the results are more likely to represent the ground truth. Based on the user making these selections to place certain assets in certain loading locations, particular embodiments receive and store this information in computer storage.

Per block 804, some embodiments extract one or more features from the user interaction results and responsively determine the ground truth. For example, the asset feature component 213 extracts the different features from assets (e.g., length, width, height, weight, delivery location) and the loading area mapping component 214 extracts features from the loading areas (e.g., length, height, width) for which the corresponding assets have been virtually placed in (and not placed in). Based on this information, particular embodiments determine a ground truth. In some embodiments, the ground truth represents each of the user interaction results. In some embodiments, the ground truth represents user interaction over some threshold, which excluded outliers. For example, if over 80% (e.g., the threshold) of users placed a particular package of X weight, and Y dimensions in the floorboard loading location of a particular vehicle, then the ground truth would be that for any package of X weight and Y dimensions (or any package within a threshold of these values), the proper loading location is the floorboard loading location for the particular vehicle, even though 20% of users placed the same package in a different loading location. In some embodiments, the “ground truth” represents the specific loading location, asset orientation, loading order, or trip number, as described herein.

Per block 806, some embodiments identify asset-loading location pairs based on the ground truth derived at block 804. For example, some embodiments pair particular assets and associated features (e.g., weight, dimensions, delivery destination) with both the correct ground truth loading location and the incorrect loading location in order to train the model per 808.

Per block 808, some embodiments train a machine learning model based on learning weights associated with the one or more features. In other words, the machine learning model takes as input, the asset-loading location pairs identified at block 806 and determines patterns associated with each pair to ultimately learn an embedding or the specific asset features and loading area parameters for a given ground truth loading location. In this way, the model learns which features and parameters are present and not present for the given ground truth over multiple iterations or epochs. Training predictions can be continuously made until a loss function is acceptable with respect to the ground truth so that each appropriate node weight or node pathway of a neural network is appropriately activated or not activated. Training is described in more detail with respect to FIG. 4.

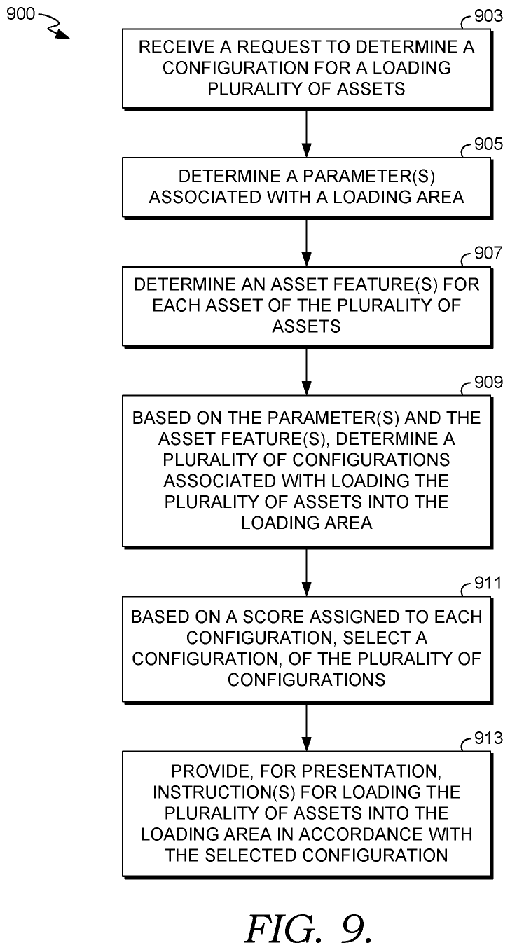

FIG. 9 is a flow diagram of an example process for providing loading instructions to users for loading a plurality of assets into a loading area in accordance with a selected configuration, according to some embodiments. Per block 903, some embodiments receive a request to determine a configuration for loading a plurality of assets. For example, some embodiments receive an indication that a user has elected a user interface button to find or select a way in which to load the plurality of assets. In some embodiments, block 903 represents receiving a request for an optimized delivery configuration for a package array. For example, referring back to FIG. 7, particular embodiments can receive an indication that a user has selected the “optimize package placement button 709). A “package array” is a plurality of packages. In some embodiments, a package array is identified or determined based on any suitable criteria, such as the specific packages that will be delivered as part of a specific route, the specific packages that will be delivered to a particular zip code or other area, and the like. An “optimized delivery configuration” refers to a configuration that is the most optimal, highest scoring, or otherwise is satisfactory for selection (e.g., even though it is not the most optimal). A “delivery configuration” refers to a predefined arrangement, manner, or way in which packages will be delivered to its respective shipping destination. For example, a delivery configuration can include a loading area arrangement, the delivery route that packages will be a part of, the vehicle used for delivery. In some embodiments, a “configuration” refers to a loading area arrangement.

Per block 905, some embodiments determine one or more parameters associated with a loading area. Examples of block 905 are described with respect to the functionality of the loading area mapping component 212. In some embodiments, the loading area is within a vehicle. In other embodiments, however, the loading area is within any suitable facility or geographical area, such as a warehouse, a work yard, a retailer, or the like. Accordingly, aspects of the invention contemplate that users may need assistance with loading or placing assets in any suitable environment, not just vehicles. For example, some users may need assistance in loading assets, such as inventory, into a warehouse. Accordingly, various embodiments may perform the process 900 and other functionality described herein for any of these use cases.

In some embodiments, the parameters define the loading area, where the loading area comprises a volume of space. For example, parameters that define the loading area can be the length, width, height, and the like of the loading area. These dimensions can include the three-dimensional volume of space between, for example, the floorboard of a trunk, the sidewalls of the vehicle adjacent to the trunk, and a portion of the roof of the vehicle associated with the trunk.

In some embodiments, the parameters defining the loading area comprises dimensions provided by the user. For example, the user may manually input the length, width, and/or height of a car trunk. Alternatively, these parameters can be determined based on data from a sensor that detects spatial features of the loading area, such as a range finder, object detection camera, ultrasound, etc., as described herein with respect to the loading area mapping component 212. In some embodiments, the parameters defining the loading area are determined based on a make, model, and year of the vehicle. Examples of this are described with respect to FIG. 7 where embodiments determine the make, model, and year based on receiving indications of selections via the UI elements 703 and 705.

Per block 907, some embodiments determine one or more asset features for each asset of the plurality of assets. Examples of such determination is described with respect to the functionality of the asset feature component 213 of FIG. 2. For example, some embodiments determine package features comprising dimensions (e.g., length, width, weight) of the assets and a shipping destination for each package of the plurality of packages. In some embodiments, a “shipping destination” refers to the final destination for a package, such as a residential or business address, a locker bank location (a locker configured to store packages), an “access point” (e.g., a retailer that partners with a logistics entity to agree to act as a pickup/delivery location for users), or geolocation coordinates (e.g., specific latitude and longitude coordinates). In some embodiments, the asset features comprise one or more of: weight of an asset, length of the asset, width of the asset, and, height of the asset. Together, length, width, and height may refer to the “volume” of each asset.

Per block 909, based on the one or more parameters (loading area) and the one or more asset features, some embodiments determine a plurality of configurations associated with loading the plurality of assets into the loading location. In some embodiments, each delivery configuration includes a set of loading area arrangements associated with delivering each package to its respective shipping destination. In other words, packages must be loaded in the loading area so that they can be delivered to its respective shipping destination. In some embodiments, each loading area arrangement comprises an orientation and a location in the loading area for one or more of the plurality of packages. An “orientation” refers the manner in which an asset is placed. For example, an orientation can refer to the position of a particular face or feature of an asset when it is loaded. For example, a package can be loaded on its side along its length such that a surface of a trunk abuts the length. Alternatively, the same package can be loaded on its top or bottom face such that the surface of the trunk abuts the top or bottom face. Accordingly, in this example, the length of the package is oriented perpendicular to the surface of the trunk such that the package abuts or sticks straight up. In some embodiments, a “location” refers to the X, Y, and/or Z three-dimensional coordinates along a surface, such as at specific coordinates on top of another asset or along a surface of a front portion of a trunk.

In an illustrative example of block 909, some embodiments use the neural network 405 to generate a plurality of candidate configurations by, for example, generating a simulation where a first package is placed in a first orientation (based on the volume of the package), at first coordinates (e.g., on top of another package in the front of the trunk), and in a particular first order in the loading area. In another example, the model generates a different simulation where the same first package is placed in a second orientation, at second coordinates (e.g., based on the weight of the package), and/or in a particular second order in the loading area. Some embodiments, for example, generate configurations by matching the dimensions of the packages (e.g., the total volume of packages combined) to the dimensions of the loading area such that in each configuration, each package fits within the total volume space of the loading area even though individual packages may be placed differently according to each configuration. Accordingly, for a given configuration, a given asset is placed in a specific orientation, location, order, and/or trip number, which is different than the specific orientation, location, order, and/or trip number of a different configuration. In some embodiments, the process 800 of FIG. 8 occurs to train such neural network in order to determine the plurality of configurations (and/or the score at block 911).

In some embodiments, each loading area arrangement is associated with a separate trip from a package loading location (e.g., a sorting facility) to a delivery area (e.g., a delivery destination). This describes what is referred to as a “trip number,” as described herein. In other words, for example, a first loading area arrangement may be that the package array is split up into two different trips, where a delivery vehicle carries a first subset of the package array to a delivery destination and the same delivery vehicle carries a second subset of the package array to the same or different delivery destinations. A “package loading location” refers to a specific location for which one or more packages are loaded into a loading area. For example, the specific location may be a sorting facility, a logistics store, a retailer, a locker bank, and the like. A “trip” as described herein refers to a vehicle travelling from the package loading location to the delivery area a single time to deliver at least a portion of the asset array. This cycle can continue for which there would be multiple trips.

In some embodiments, a number of loading area arrangements in a respective set corresponds to a quantity of return trips to a package loading location that is associated with the respective delivery configuration. For example, if the vehicle has made a delivery for a first trip to a delivery destination, the vehicle may then have to travel from the delivery destination back to the package loading location. After the user has once again loaded the vehicle with another set of assets, the vehicle once again travels from the package loading location (which triggers or initiates a second trip) to the same or different delivery area.

In some embodiments, block 909 includes determining of a plurality of delivery configurations based on the dimensions of the volume of space for receiving packages at the loading area and based on the package features. This is described with respect to the configuration component 214 and the loading area mapping component 212 of FIG. 2. For example, based on the length, width, and/or height of a trunk of a car being X dimensions, and based on an aggregate volume of the packages being less than the X dimensions, particular embodiments determine a configuration—determine that specific packages can fit within the trunk loading area.

Per block 911, based on a score assigned to each configuration, some embodiments select a configuration, of the plurality of configurations. To “select” a configuration can mean to “identify,” “predict” or “estimate” that the configuration is suitable (without being the most optimal), optimal, or it can mean to “choose” or “flag” the configuration for display at a user interface (e.g., because it is one of multiple suitable configuration candidates). Examples of block 911 are described with respect to the configuration selection component 218 of FIG. 2 or the one or more predictions 407 of FIG. 4. Some embodiments directly assign the score to each configuration, of the plurality of configurations, as described, for example, with respect to the scoring component 216 of FIG. 2. In some embodiments, block 911 includes determining a particular delivery configuration is the optimized delivery configuration based on scores assigned to the plurality of delivery configurations (and/or because the “optimized delivery configuration” is the highest score). In some embodiments, block 911 includes based on the score for each of the plurality of delivery configurations, identifying a delivery configuration, of the plurality of delivery configurations, as the optimized delivery configuration for the package array (e.g., because the optimized delivery configuration scored the highest).

In some embodiments, the “score” indicated at block 911 (e.g., the score for the respective delivery configuration) is based on the number of return trips (also referred to herein as “trip number”) associated with the respective delivery configuration. For instance, the fewer return trips, the higher the score. Put another way, the more return trips, the lower the score is. In an illustrative example, a single trip from a sorting facility to a delivery destination (e.g., a residential address) is worth 10 points, whereas a second trip from the sorting facility to the same or different delivery destination (e.g., but that which is within a threshold distance) is only worth 5 points, because of the waste in time and other resources, such as fuel and money. In this way, in some embodiments, the optimized delivery configuration minimizes the number of return trips required. Thus, a delivery configuration will be selected, for example, if all packages in a neighborhood can be delivered in a single trip, as opposed to a delivery configuration that requires the packages in the neighborhood to be split up into two or more trips.

In some embodiments, the score for a respective delivery configuration is based on a number of loading area arrangements in the respective set. For instance, the more loading areas there are in a vehicle, the higher the score (the more optimal the configuration is) or the more loading area arrangements there are in a vehicle, the higher the score.

In some embodiments, the score for a respective delivery configuration is associated with a total time associated with delivering the plurality of packages. For instance, the longer it takes to deliver all of the plurality of packages, the lower the score. And the shorter time it takes to delivery all of the plurality of packages, the higher the score (e.g., the more optimal the configuration is). For example, for a first configuration it may take 1 hour to deliver all the packages in an array. For a second configuration, it may only take 30 minutes to deliver the same packages. Accordingly, the second configuration would be scored higher. Some embodiments, calculate the total time via GPS or other tools. Some embodiments make this calculation by detecting a distance from one destination location to another of each package in the array and mapping the distance to time. In this way, the score may also be associated with the total distance traveled associated with delivery the plurality of packages. For example, there is a higher score where two packages in a same neighborhood are delivered in consecutive stops, as opposed making a first stop in a first neighborhood to deliver a package, making a second stop at a different neighborhood to deliver another package, and then returning back through the first neighborhood to deliver another package.

In some embodiments, the score for a respective delivery configuration is based on a spatial proximity of packages having the same shipping destination according to the respective set of loading area arrangements. Similar to what is described in the paragraph directly above, for these shipments that have a same shipping destination (or are within a threshold distance of each other), some embodiments determine whether the configuration indicates that the corresponding packages are within a threshold distance or spatial proximity within each other in a loading are location. For instance, for packages that are arriving at the same consignee destination address, the closer the packages are closer to each other, the higher the score. Oppositely, the farther away the packages are from each other, the lower the score. The idea is typically to keep packages near each other for the same destination so that the driver does not have to parse through multiple areas in a vehicle and packages to get to the packages that will be delivered to a single shipping destination.

Returning to FIG. 9, per block 913, some embodiments provide, for presentation, one or more instructions for loading the plurality of assets in to the loading area in accordance with the selected configuration. In some embodiments, “providing for presentation” can include “causing display of,” “causing presentation of,” “generating,” “rendering,” or directly displaying information. Examples of block 913 are described with respect to the presentation component 220 of FIG. 2, the display screen 102-1 of FIG. 1, and/or the screenshot 600 of FIG. 6.

In some embodiments, block 913 includes providing for presentation instructions for loading the delivery vehicle in accordance with the set of loading area arrangements associated with the optimized delivery configuration (e.g., as described with respect to the display screen 102-1 of FIG. 1). In some embodiments, the instructions comprise step-by-step instructions for loading each of the plurality of packages in a particular orientation and a particular loading location with the loading area. Example of this is described with respect to the display screen 102-1 of FIG. 1 and the UI element 612 (and the virtual objects 614, 616, and 618) of FIG. 6. It is understood the step-by-step instructions for loading each of the plurality of packages need not occur in a logistics context. Rather, for example, the step-by-step instructions can be to load any amount of assets into any loading location of any suitable facility or area, such as a warehouse.

II. Apparatuses, Methods, and Systems

Embodiments of the present disclosure may be implemented in various ways, including as apparatuses that comprise articles of manufacture. An apparatus may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double information/data rate synchronous dynamic random access memory (DDR SDRAM), double information/data rate type two synchronous dynamic random access memory (DDR2 SDRAM), double information/data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices/entities, computing entities, and/or the like. As such, embodiments of the present disclosure may take the form of an apparatus, system, computing device, computing entity, and/or the like executing instructions stored on a computer-readable storage medium to perform certain steps or operations. However, embodiments of the present disclosure may also take the form of an entirely hardware embodiment performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices/entities, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

FIG. 10 is a schematic diagram of an example computing environment 1000A in which aspects of the present disclosure are employed in, according to some embodiments. As shown in FIG. 10, this particular computing environment 1000A includes one or more analysis computing entities 05, one or more computing entities 10 (e.g., a mobile devices), one or more satellites 12, one or more networks 210, and/or the like. Each of these components, entities, devices, systems, and similar words used herein interchangeably may be in direct or indirect communication with, for example, one another over the same or different wired and/or wireless networks. Additionally, while FIG. 10 illustrates the various system entities as separate, standalone entities, the various embodiments are not limited to this particular architecture. In some embodiments, the components of the system 200 are included in the environment 1000A. In some embodiments, all of the components of the system 200 are included in the one or more analysis computing entities 05. In some embodiments, all of the components of the system 200 are included in the one or more computing entities 10. In some embodiments, the components of the system 200 are distributed among both the analysis computing entity 05 and the computing entity 10.

In various embodiments, the network(s) 210 represents or includes an IoT or IoE network, which is a network of interconnected items that are each provided with unique identifiers (e.g., UIDs) and computing logic so as to communicate or transfer data with each other or other components.

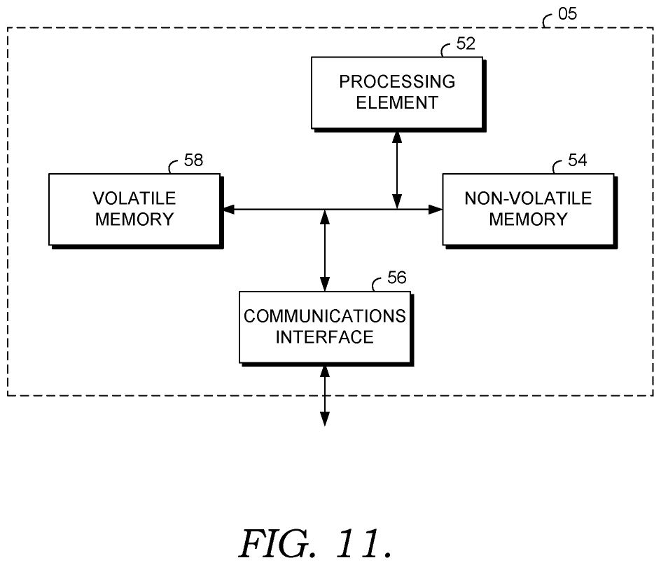

FIG. 11 is a block diagram of an analysis computing entity 05, according to some embodiments. In general, the terms computing entity, computer, entity, device, system, and/or similar words used herein interchangeably may refer to, for example, one or more computers, computing entities, desktops, mobile phones, tablets, phablets, notebooks, laptops, distributed systems, consoles input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In particular embodiments, these functions, operations, and/or processes can be performed on data, content, information/data, and/or similar terms used herein interchangeably.

As indicated, in particular embodiments, the analysis computing entity 05 may also include one or more communications interfaces 56 for communicating with various computing entities, such as by communicating data, content, information/data, and/or similar terms used herein interchangeably that can be transmitted, received, operated on, processed, displayed, stored, and/or the like.

FIG. 11 is a block diagram of a computing entity 05 of FIG. 10, according to some embodiments. As shown in FIG. 11, in particular embodiments, the analysis computing entity 05 may include or be in communication with one or more processing elements 52 (also referred to as processors, processing circuitry, and/or similar terms used herein interchangeably) that communicate with other elements within the analysis computing entity 05 via a bus, for example. As will be understood, the processing element 52 may be embodied in a number of different ways. For example, the processing element 52 may be embodied as one or more complex programmable logic devices (CPLDs), microprocessors, multi-core processors, co-processing entities, application-specific instruction-set processors (ASIPs), microcontrollers, and/or controllers. Further, the processing element 04 may be embodied as one or more other processing devices or circuitry. The term circuitry may refer to an entirely hardware embodiment or a combination of hardware and computer program products. Thus, the processing element 52 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 04 may be configured for a particular use or configured to execute instructions stored in volatile or non-volatile media or otherwise accessible to the processing element 52. As such, whether configured by hardware or computer program products, or by a combination thereof, the processing element 04 may be capable of performing steps or operations according to embodiments of the present disclosure when configured accordingly.

In particular embodiments, the analysis computing entity 05 may further include or be in communication with non-volatile media (also referred to as non-volatile storage, memory, memory storage, memory circuitry and/or similar terms used herein interchangeably). In particular embodiments, the non-volatile storage or memory may include one or more non-volatile storage or memory media 54, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases (e.g., parcel/item/shipment database), database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or information/data that is stored in a computer-readable storage medium using one or more database models, such as a hierarchical database model, network model, relational model, entity-relationship model, object model, document model, semantic model, graph model, and/or the like.

In particular embodiments, the analysis computing entity 05 may further include or be in communication with volatile media 58 (also referred to as volatile storage, memory, memory storage, memory circuitry and/or similar terms used herein interchangeably). In particular embodiments, the volatile storage or memory may also include one or more volatile storage or memory media 58, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 52. Thus, the databases, database instances, database management systems, data, applications, programs, program modules, scripts, source code, object code, byte code, compiled code, interpreted code, machine code, executable instructions, and/or the like may be used to control certain aspects of the operation of the analysis computing entity 05 with the assistance of the processing element 52 and operating system.

As indicated, in particular embodiments, the analysis computing entity 05 may also include one or more communications interfaces 56 for communicating with various computing entities, such as by communicating information/data, content, information/data, and/or similar terms used herein interchangeably that can be transmitted, received, operated on, processed, displayed, stored, and/or the like. Such communication may be executed using a wired information/data transmission protocol, such as fiber distributed information/data interface (FDDI), digital subscriber line (DSL), Ethernet, asynchronous transfer mode (ATM), frame relay, information/data over cable service interface specification (DOCSIS), or any other wired transmission protocol. Similarly, the analysis computing entity 05 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra wideband (UWB), infrared (IR) protocols, near field communication (NFC) protocols, Wibree, Bluetooth protocols, wireless universal serial bus (USB) protocols, long range low power (LoRa), LTE Cat M1, NarrowBand IoT (NB IoT), and/or any other wireless protocol.

Although not shown, the analysis computing entity 05 may include or be in communication with one or more input elements, such as a keyboard input, a mouse input, a touch screen/display input, motion input, movement input, audio input, pointing device input, joystick input, keypad input, and/or the like. The analysis computing entity 05 may also include or be in communication with one or more output elements (not shown), such as audio output, video output, screen/display output, motion output, movement output, and/or the like.

As will be appreciated, one or more of the analysis computing entity's 05 components may be located remotely from other analysis computing entity 05 components, such as in a distributed system. Additionally or alternatively, the analysis computing entity 05 may be represented among a plurality of analysis computing entities. For example, the analysis computing entity 05 can be or be included in a cloud computing environment, which includes a network-based, distributed/data processing system that provides one or more cloud computing services. Further, a cloud computing environment can include many computers, hundreds or thousands of them or more, disposed within one or more data centers and configured to share resources over the network(s) 210. Furthermore, one or more of the components may be combined and additional components performing functions described herein may be included in the analysis computing entity 05. Thus, the analysis computing entity 05 can be adapted to accommodate a variety of needs and circumstances. As will be recognized, these architectures and descriptions are provided for exemplary purposes only and are not limiting to the various embodiments.

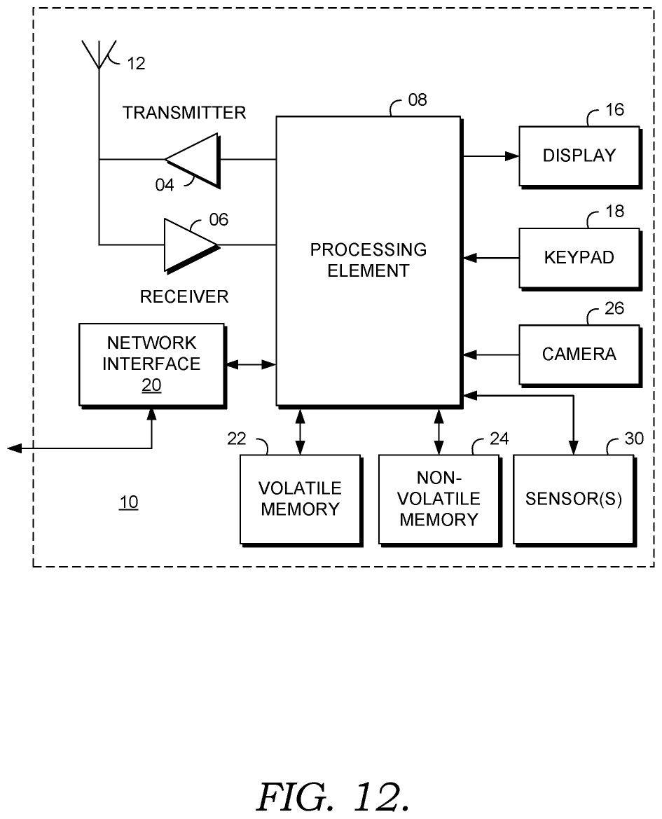

FIG. 12 is a block diagram of a computing entity 10 of FIG. 10, according to some embodiments. In certain embodiments, computing entities 10 may be embodied as handheld computing entities, such as mobile phones, tablets, personal digital assistants, and/or the like, that may be operated at least in part based on user input received from a user via an input mechanism. Moreover, computing entities 10 may be embodied as onboard vehicle computing entities, such as central vehicle electronic control units (ECUs), onboard multimedia system, and/or the like that may be operated at least in part based on user input. Such onboard vehicle computing entities may be configured for autonomous and/or nearly autonomous operation however, as they may be embodied as onboard control systems for autonomous or semi-autonomous vehicles, such as unmanned aerial vehicles (UAVs), robots, and/or the like. As a specific example, computing entities 10 may be utilized as onboard controllers for UAVs configured for picking-up and/or delivering packages to various locations, and accordingly such computing entities 10 may be configured to monitor various inputs (e.g., from various sensors) and generated various outputs. It should be understood that various embodiments of the present disclosure may comprise a plurality of computing entities 10 embodied in one or more forms (e.g., parcel security devices kiosks, mobile devices, watches, laptops, carrier personnel devices (e.g., Delivery Information Acquisition Devices (DIAD)), etc.)

As will be recognized, a user may be an individual, a family, a company, an organization, an entity, a department within an organization, a representative of an organization and/or person, and/or the like—whether or not associated with a carrier. In particular embodiments, a user may operate a computing entity 10 that may include one or more components that are functionally similar to those of the analysis computing entity 05. FIG. 12 provides an illustrative schematic representative of a computing entity 10 that can be used in conjunction with embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, vehicle multimedia systems, autonomous vehicle onboard control systems, watches, glasses, key fobs, radio frequency identification (RFID) tags, ear pieces, scanners, imaging devices/cameras (e.g., part of a multi-view image capture system), wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Computing entities 10 can be operated by various parties, including carrier personnel (sorters, loaders, delivery drivers, network administrators, and/or the like). As shown in FIG. 12, the computing entity 10 can include an antenna 12, a transmitter 04A (e.g., radio), a receiver 06 (e.g., radio), and a processing element 08 (e.g., CPLDs, microprocessors, multi-core processors, coprocessing entities, ASIPs, microcontrollers, and/or controllers) that provides signals to and receives signals from the transmitter 04A and receiver 06, respectively. In some embodiments, the computing entity 10 includes one or more sensors 30. In this way, in some embodiments, the computing entity 10 is a special-purpose computer or particular machine. The one or more sensors 30 can be one or more of: a pressure sensor, an accelerometer, a gyroscope, a geolocation sensor (e.g., GPS sensor), a radar, a LIDAR, sonar, ultrasound, an object recognition camera, and any other suitable sensor described herein to map a loading area.

The signals provided to and received from the transmitter 04A and the receiver 06, respectively, may include signaling information in accordance with air interface standards of applicable wireless systems. In this regard, the computing entity 10 may be capable of operating with one or more air interface standards, communication protocols, modulation types, and access types. More particularly, the computing entity 10 may operate in accordance with any of a number of wireless communication standards and protocols, such as those described above with regard to the analysis computing entity 05. In a particular embodiment, the computing entity 10 may operate in accordance with multiple wireless communication standards and protocols, such as UMTS, CDMA2000, 1×RTT, WCDMA, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the computing entity 10 may operate in accordance with multiple wired communication standards and protocols, such as those described above with regard to the analysis computing entity 05 via a network interface 20.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system.

According to particular embodiments, the computing entity 10 may include location determining aspects, devices, modules, functionalities, and/or similar words used herein interchangeably. For example, the computing entity 10 may include outdoor positioning aspects, such as a location module adapted to acquire, for example, latitude, longitude, altitude, geocode, course, direction, heading, speed, universal time (UTC), date, and/or various other information/data. In particular embodiments, the location module can acquire information/data, sometimes known as ephemeris information/data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This information/data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information can be determined by triangulating the computing entity's 10 position in connection with a variety of other systems, including cellular towers, Wi-Fi access points, and/or the like. Similarly, the computing entity 10 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices/entities (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The computing entity 10 may also comprise a user interface (that can include a display 16 coupled to a processing element 08) and/or a user input interface (coupled to a processing element 08). For example, the user interface may be a user application, browser, user interface, and/or similar words used herein interchangeably executing on and/or accessible via the computing entity 10 to interact with and/or cause display of information from the analysis computing entity 05, as described herein. The user input interface can comprise any of a number of devices or interfaces allowing the computing entity 10 to receive information/data, such as a keypad 318 (hard or soft), a touch display, voice/speech or motion interfaces, or other input device. In embodiments including a keypad 18, the keypad 18 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

As shown in FIG. 12, the computing entity 10 may also include an camera, imaging device, and/or similar words used herein interchangeably 26 (e.g., still-image camera, video camera, IoT enabled camera, IoT module with a low resolution camera, a wireless enabled MCU, and/or the like) configured to capture images. The computing entity 10 may be configured to capture images via the onboard camera 26, and to store those imaging devices/cameras locally, such as in the volatile memory 22 and/or non-volatile memory 24. As discussed herein, the computing entity 10 may be further configured to match the captured image data with relevant location and/or time information captured via the location determining aspects to provide contextual information/data, such as a time-stamp, date-stamp, location-stamp, and/or the like to the image data reflective of the time, date, and/or location at which the image data was captured via the camera 26. The contextual data may be stored as a portion of the image (such that a visual representation of the image data includes the contextual data) and/or may be stored as metadata (e.g., data that describes other data, such as describing a payload) associated with the image data that may be accessible to various computing entities 10.

The computing entity 10 may include other input mechanisms, such as scanners (e.g., barcode scanners), microphones, accelerometers, RFID readers, and/or the like configured to capture and store various information types for the computing entity 10. For example, a scanner may be used to capture parcel/item/shipment information/data from an item indicator disposed on a surface of a shipment or other item. In certain embodiments, the computing entity 10 may be configured to associate any captured input information/data, for example, via the onboard processing element 08. For example, scan data captured via a scanner may be associated with image data captured via the camera 26 such that the scan data is provided as contextual data associated with the image data.

The computing entity 10 can also include volatile storage or memory 22 and/or non-volatile storage or memory 24, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, information/data, applications, programs, program modules, scripts, source code, object code, byte code, compiled code, interpreted code, machine code, executable instructions, and/or the like to implement the functions of the computing entity 10. As indicated, this may include a user application that is resident on the entity or accessible through a browser or other user interface for communicating with the analysis computing entity 05 and/or various other computing entities.

In another embodiment, the computing entity 10 may include one or more components or functionality that are the same or similar to those of the analysis computing entity 05, as described in greater detail above. As will be recognized, these architectures and descriptions are provided for exemplary purposes only and are not limiting to the various embodiments.

The term “user” described herein may refer to a human user, a robot, an artificial intelligence entity, or a program, such as a service.

What is claimed is:

1. A system for optimizing a package array in a loading area of a delivery vehicle, the system comprising:
one or more processors; and
one or more computer storage devices storing computer-useable instructions that, when executed by the one or more processors, cause the system to perform operations comprising:
receiving a request for an optimized delivery configuration for the package array, the package array comprising a plurality of packages;
determining parameters defining the loading area of the delivery vehicle, the loading area comprising a volume of space for receiving packages;
determining package features for each of the plurality of packages, the package features comprising dimensions and a shipping destination;
based on the parameters defining the loading area and on the package features, determining a plurality of delivery configurations, each delivery configuration comprising a set of loading area arrangements associated with delivering each of the plurality of packages to its respective shipping destination;
assigning a score to each of the plurality of delivery configurations;
based on the score for each of the plurality of delivery configurations, identifying a delivery configuration of the plurality of delivery configurations as the optimized delivery configuration for the package array; and
providing for presentation instructions for loading the delivery vehicle in accordance with the set of loading area arrangements associated with the optimized delivery configuration.

2. The system of claim 1, wherein each loading area arrangement comprises an orientation and a location in the loading area for one or more of the plurality of packages.

3. The system of claim 1, wherein each loading area arrangement is associated with a separate trip from a package loading location to a delivery area.

4. The system of claim 1, wherein a number of loading area arrangements in a respective set corresponds to a number of return trips to a package loading location that is associated with the respective delivery configuration.

5. The system of claim 4, wherein the score for the respective delivery configuration is based on the number of return trips associated with the respective delivery configuration.

6. The system of claim 5, wherein the optimized delivery configuration minimizes the number of return trips.

7. The system of claim 1, wherein the score for a respective delivery configuration is based on a number of loading area arrangements in the respective set.

8. The system of claim 1, wherein the score for a respective delivery configuration is associated with a total time associated with delivering the plurality of packages.

9. The system of claim 1, wherein the parameters defining the loading area comprise dimensions provided by a user, and wherein the delivery vehicle is one of: a personal vehicle or a standardized delivery vehicle.

10. The system of claim 1, wherein the parameters defining the loading area are determined based on a make, model, and year of the delivery vehicle.

11. The system of claim 1, wherein the parameters defining the loading area are determined based on data from a sensor that detects spatial features of the loading area.

12. The system of claim 1, wherein the instructions comprise step-by-step instructions for loading each of the plurality of packages in a particular orientation and a particular location within the loading area.

13. The system of claim 1, wherein the score for a respective delivery configuration is based on a spatial proximity of packages having the same shipping destination according to the respective set of loading area arrangements.

14. A computer-implemented method comprising:
receiving a request for an optimized configuration for a plurality of assets;
determining one or more parameters associated with a loading area;
determining one or more asset features for each asset of the plurality of assets;
based on the one or more parameters and the one or more asset features, determining a plurality of configurations, each configuration comprising a set of loading area arrangements associated with loading the plurality of assets into the loading area;
based on a score assigned to each delivery configuration, of the plurality of delivery configurations, determining a particular configuration is the optimized configuration; and
providing for presentation one or more instructions for loading the plurality of assets into the loading area in accordance with the set of loading area arrangements associated with the optimized delivery configuration.

15. The method of claim 14, wherein the asset features comprise one or more of: weight of an asset, length of the asset, width of the asset, and height of the asset.

16. The method of claim 14, wherein the one or more instructions comprise step-by-step instructions for loading each of the plurality of assets in a particular orientation and a particular location within the loading area.

17. One or more computer storage media having computer-executable instructions embodied thereon that, when executed, perform a method comprising:
receiving a request for an optimized delivery configuration for a plurality of packages;
determining dimensions of a volume of space for receiving packages at a loading area of a delivery vehicle;
determining package features for each of the plurality of packages, the package features comprising dimensions and a shipping destination;
based on the dimensions of the volume of space for receiving packages at the loading area and on the package features, determining a plurality of delivery configurations, each delivery configuration comprising a set of loading area arrangements, each loading area arrangement associated with a trip for delivering one or more of the plurality of packages from a package loading location to their respective shipping destinations;
based on scores assigned to the plurality of delivery configurations, determining a particular delivery configuration is the optimized delivery configuration; and
providing for presentation instructions for loading the delivery vehicle in accordance with the set of loading area arrangements associated with the optimized delivery configuration.

18. The computer storage media of claim 17, wherein the optimized delivery configuration minimizes a number of return trips to the package loading location.

19. The computer storage media of claim 17, wherein the scores assigned to the plurality of delivery configurations are based on a number of return trips to the package loading location.

20. The computer storage media of claim 17, wherein the scores assigned to the plurality of delivery configurations are based on a total time associated with delivering the plurality of packages.
